(19) United States
(12) Patent Application Publication
(10) Pub. No.: US 2025/0216707 A1
(43) Pub. Date: Jul. 3, 2025

(54) POLARISATION CONTROL

(71) Applicant: SMART PHOTONICS HOLDING B.V., Eindhoven (NL)

(72) Inventors: Madeleine NILSEN, Eindhoven (NL); Alonso Jesús MILLÁN-MEJÍA, Eindhoven (NL)

(21) Appl. No.: 19/080,527

(22) Filed: Mar. 14, 2025

Related U.S. Application Data
(63) Continuation of application No. PCT/EP2023/075335, filed on Sep. 14, 2023.

(30) Foreign Application Priority Data
Sep. 15, 2022 (GB) 2213523.0

(51) Int. Cl. G02F 1/01; G02F 1/015

(52) U.S. Cl. CPC G02F 1/0136; G02F 1/0151

(57) ABSTRACT

A polarisation control device for a photonic integrated circuit, comprising a first polarisation converter and a second polarisation converter. The first polarisation converter has a first cross-sectional structure and supports a first mode and a second mode having different effective refractive indices to each other and having different orientations of polarisation to each other. The second polarisation converter has a second cross-sectional structure and supports a third mode and a fourth mode having different effective refractive indices to each other and having different orientations of polarisation to each other. A control element modifies the effective refractive indices in response to a signal.

### CROSS-REFERENCE TO RELATED APPLICATIONS

This application is a continuation under 35 U.S.C. § 120 of International Application No. PCT/EP2023/075335, filed Sep. 14, 2023, which claims priority to United Kingdom Application No. GB 2213523.0, filed Sep. 15, 2022 under 35 U.S.C. § 119 (a). Each of the above-referenced patent applications is incorporated by reference in its entirety.

### BACKGROUND

Polarisation control systems can be used in photonic integrated circuits (PICs) to perform control of polarisation of light. A polarisation control system may be designed and manufactured for use in a particular application within a PIC. For example, a PIC may comprise a polarisation control system for changing light of a first polarisation to light of a second polarisation.

### BRIEF DESCRIPTION OF THE DRAWINGS

FIG. 1 illustrates schematically a top-down view of a first light polarisation control device according to first examples.

FIG. 2 illustrates schematically a cross-sectional structure of the first polarisation converter of the light polarisation control device according to the first examples.

FIG. 3 illustrates schematically a cross-sectional structure of a first and a second polarisation converter of a light polarisation control device according to the first examples.

FIGS. 4a and 4b illustrate schematically a first polarisation of light and a second polarisation of light guided by a polarisation converter according to examples.

FIGS. 5a and 5b illustrate schematically a side cross-section of the first and the second light polarisation converter according to the first examples.

FIGS. 6a, 6b, 7a and 7b illustrate schematically control of a state of polarisation of light using a polarisation control device according to examples.

FIG. 8 illustrates schematically a top-down view of a polarisation control device according to second examples, and a diagram of a Poincaré sphere illustrating the polarisation control of the polarisation control device according to the second examples.

FIG. 9 illustrates schematically a top-down view of a light polarisation control device according to further examples.

FIG. 10 illustrates schematically a cross-sectional structure of a polarisation converter of a light polarisation control device according to further examples.

FIG. 11 illustrates schematically a cross-sectional structure of a polarisation converter of a light polarisation control device according to yet further examples.

FIG. 12 illustrates schematically a cross-sectional structure of a polarisation converter of a light polarisation control device according to still further examples.

FIG. 13 illustrates schematically a cross-sectional structure of a polarisation converter of a light polarisation control device according to still yet further examples.

FIG. 14 illustrates schematically a system comprising a photonic integrated circuit featuring the polarisation control device of FIG. 1 according to examples.

FIG. 15 is a flow diagram illustrating a method of controlling the polarisation state of light in a photonic integrated circuit using a polarisation control device described herein according to examples.

FIG. 16 is a flow diagram illustrating a method of fabricating a polarisation control device described herein according to further examples.

### DETAILED DESCRIPTION

Examples described herein relate to a semiconductor structure for a PIC. More specifically, the examples described herein relate to a light polarisation control device for a

PIC. Such a light polarisation control device may be, for example, a polarisation scrambler, or a polarisation controller, and may be referred to merely as a polarisation control device.

In some examples, a PIC is constructed from basic building blocks intended for the construction of the PIC. The basic building blocks include various components, each having a particular function. An example of a basic building block is a waveguide structure. Basic building blocks may have a particular effect on light incident thereon. The examples described herein relate to a light polarisation control device that can be used as a basic building block for a PIC.

A light polarisation control device is a device which is for example useable to actively control light polarisation. Active control refers to the state of light polarisation being dynamically modifiable during use of the device. In this way, the functionality of the device is itself dynamically modifiable during use, in contrast to a passive effect where the functionality of a device is fixed upon fabrication of the device. For example, a suitably configured light polarisation control device can be used to modify the polarisation of any input polarisation into a specific output polarisation. For example, an arbitrary input polarisation (e.g. linear, elliptical, or circular) is changed by the suitably configured light polarisation control device into vertically polarised light. In such an example, the polarisation control device acts as a polarisation controller. In another example, an input polarisation can be modified into a random output polarisation. At a first instance, a vertically polarised input can be changed to an elliptical polarisation, and at a second instance, the vertically polarised input can be changed to a circular polarisation, and at a third instance, the vertically polarised input can be changed to a linear polarisation. In such an example, the polarisation control device acts as a polarisation scrambler.

Light polarisation control devices can be manufactured from a combination of polarisation converters, which are usually passive devices producing a fixed change to the polarisation state, arranged in series with interferometers, and phase-shifters. The sequence of components (polarisation converters, interferometers, and phase-shifters) required to realise a polarisation controller is in general different to the sequence of components required to realise a polarisation scrambler, for example. The accuracy of polarisation scramblers and controllers in such examples can be dependent on the performance of the constituent polarisation converters.

In examples described herein, a polarisation control device herein comprises a combination of actively-controlled polarisation convertors, such that the same combination of components can be used to realise a plurality of different functions, such as the functionality of a polarisation controller and/or a polarisation scrambler.

In examples described herein, a polarisation control device has: a first polarisation converter having a first cross-sectional structure, the first polarisation converter supporting a first mode and a second mode which have different orientations of polarisation and different effective refractive indices, and a second polarisation converter having a second cross-sectional structure, the second polarisation converter supporting a third mode and a fourth mode which have different orientations of polarisation and different effective refractive indices. At least one control element is configured to alter the effective refractive indices of the first, second, third and fourth modes. The combination of these features, in examples, gives a more compact polarisation control device than known polarisation control devices, which reduces a footprint (surface area occupied) of the polarisation control device on a PIC. The polarisation control device can additionally fulfil the function of both polarisation controller and polarisation scrambler with suitable control signals.

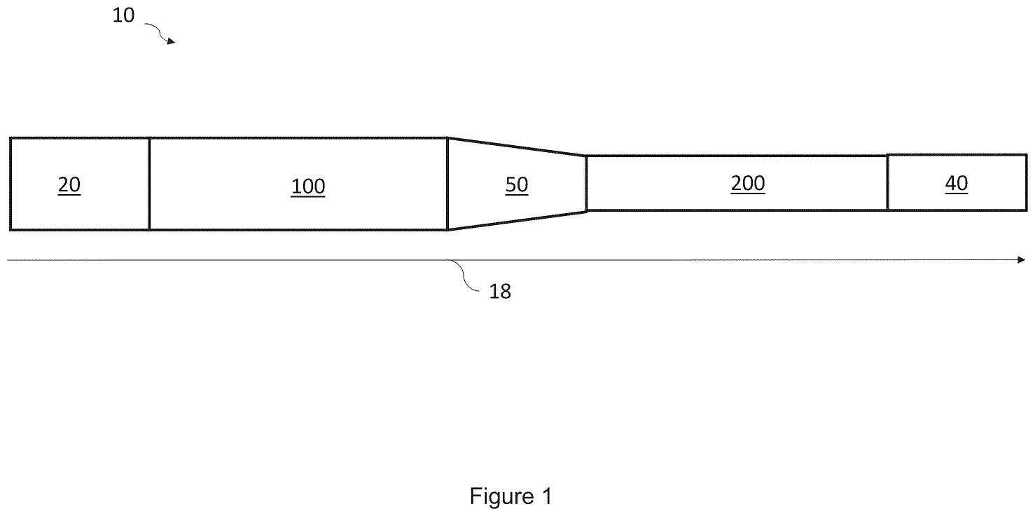

FIG. 1 illustrates schematically a top-down view of a light polarisation control device 10 of first examples. The light polarisation control device 10 is for a PIC. In FIG. 1, the light polarisation control device 10 comprises an input waveguide 20, a first polarisation converter 100, a connecting waveguide 50, a second polarisation converter 200 and an output waveguide 40 arranged in series. That is, in use, the output of the input waveguide 20 is received at the input of the first polarisation converter 100, the output of the first polarisation converter 100 is received at the input of the connecting waveguide 50, the output of the connecting waveguide 50 is received at the input of the second polarisation converter 200 and the output of the second polarisation converter 200 is received at the input of the output waveguide 40. The skilled person will appreciate that the reverse relationship, wherein light propagates in the reverse direction to that described above, is also true for the described components in series. More generally, a light polarisation control device according to examples herein comprises at least two polarisation converters arranged in series, and in examples may comprise an input waveguide, an output waveguide and a plurality of connecting waveguide sections to join the input waveguide, the output waveguide and a plurality of polarisation converters. In use, light can be considered to propagate through the light polarisation control device 10 in a direction substantially parallel to a light propagation axis, which is indicated in FIG. 1 by the arrow 18.

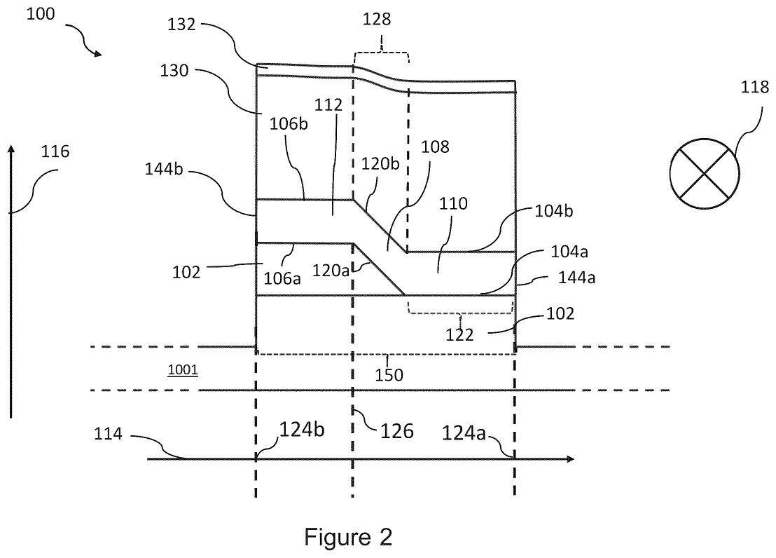

FIG. 2 illustrates schematically a side cross-section of the first polarisation converter 100 of the polarisation control device 10 of FIG. 1; the side cross-section shows a cross-sectional structure of the first polarisation converter 100 viewed in a cross-sectional plane perpendicular to a first light propagation axis LPA, which in FIG. 2 is into the page, as indicated by symbol 118. The light polarisation converter 100 is for a PIC, a substrate plane of the PIC 1001 being below the light polarisation convertor 100 in FIG. 2. The light polarisation converter 100 comprises a substrate 102. In some examples, the substrate 102 comprises a so-called III-V semiconductor compound such as Indium Phosphide (InP), gallium arsenide (GaAs), gallium nitride (GaN) or gallium antimonide (GaSb). In other examples, the substrate 102 comprises a Nitride based material or a Silicon based material, for example, silicon carbide.

The cross-sectional structure of a polarisation converter refers to the composition of the polarisation converter in a cross-sectional plane perpendicular to a light propagation axis of the polarisation converter. That is, it refers to the geometry of and material composition of constituent layers which form the polarisation converter, the geometry described in the plane perpendicular to the light propagation axis. More generally, the cross-sectional structure of a component configured to guide light refers herein to the geometry and material composition of constituent layers which form the component in a cross-sectional plane perpendicular to a light propagation axis of the component. The cross-sectional structure of the light polarisation converter 100 comprises a first waveguide layer 108 between, and in contact with, a first cladding layer 130 and a second cladding layer, which in this example is the substrate 102. An electrical contact layer 132 is on top of the cladding layer 130. The electrical contact layer 132 is an element, for, responsive to a signal, applying an electrical field across the first and second cladding layers and the first waveguide layer 108 to the substrate. This will modify the refractive index of the first and second cladding layers and the first waveguide layer 108 by an electro-optic effect such as a Pockels effect, Kerr effect, plasma and/or band-filling effects, the use of which will be described later.

The first waveguide layer 108 comprises a first portion 110 partially bounded by, and in contact with, a first surface 104a of the substrate 102 and a second surface 104b of the first cladding layer 130, and a second portion 112 partially bounded by, and in contact with, a third surface 106a of the substrate and a fourth surface 106b of the first cladding layer 130. The first surface 104a, the second surface 104b, the third surface 106a, and the fourth surface 106b are parallel to each other.

The first surface 104a is offset from the third surface 106a along a first axis 114 and a second axis 116 each perpendicular to a light propagation axis for converting polarisation of light. The first surface 104a is connected to the third surface 106a by a first joining surface 120a of the substrate 102. The second surface 104b is offset from the fourth surface 106b along the first axis 114 and the second axis 116. The second surface 104b is connected to the fourth surface 106b by a second joining surface 120b of the first cladding layer 130. The second portion 112 is thereby offset from the first portion 110. The first axis 114 is perpendicular to the second axis 116. The first joining surface 120a is, in this example, parallel to the second joining surface 120b.

The first axis 114 is the horizontal axis with respect to the orientation shown in FIG. 2, and the second axis 116 is the vertical axis with respect to the orientation shown in FIG. 2. For example, the first axis 114 extends in a direction from the first surface 104a towards the third surface 106b. As referred to herein, widths of parts of the light polarisation converter 100 are along the first axis 114. As referred to herein, lengths of various parts described herein are along the first light propagation axis as indicated by the symbol 118. As referred to herein, the terms height, upper and lower are with respect to the second axis 116. In the orientation shown in FIG. 2, the first surface 104a is a lower surface of the substrate 102, and the third surface 106a is an upper surface of the substrate 102. The upper surface 106a provides a step upwards (in a direction parallel to the vertical axis) from the lower surface 104a. Therefore, in these examples, the first surface 104a and the third surface 106a are offset in position along the vertical axis 116, e.g. so that the first surface 104a and the third surface 106a are displaced and/or vertically spaced from each other, and the second surface 104b and fourth surface 106b are displaced and/or vertically spaced from each other.

The first waveguide layer 108 having the first portion 110 in contact with the first surface 104a and the second surface 104b, and the second portion 112 in contact with the third surface 106a and fourth surface 106b means that there is provided a first waveguide layer 108 in which light can propagate along the first light propagation axis indicated by the symbol 118 with different portions offset from one another in a direction parallel to the vertical axis 116.

In the examples of FIG. 2, the first joining surface 120a and second joining surface 120b are sloped surfaces. As referred to herein, one surface being sloped relative to another surface means that there is a non-zero angle between the two surfaces in question, and that the angle between the two surfaces is obtuse or acute. In such contexts, reference can be made to a surface being tilted relative to another surface. The terms “tilt”, “angle” and “slope” are used interchangeably herein to refer to the angle of an entity relative to another entity or relative to a given axis. For example, in FIG. 2, the first joining surface 120a has an obtuse internal angle relative to the first surface 104a and the third surface 106a. In other words, the first joining surface 120a is non-orthogonal to the first surface 104a and the third surface 106a.

The second joining surface 120b has obtuse internal angles relative to the second surface 104b and the fourth surface 106b. In other words, the second joining surface 120b is non-orthogonal to the second surface 104b and the fourth surface 106b. As referred to herein, the first joining surface 120a being between the first surface 104a and the third surface 106a means, for example, that the first joining surface 120a is interposed between the first surface 104a and the third surface 106a and is for example immediately adjacent to each of the first surface 104a and the third surface 106a. Thus, the first joining surface 120a, first surface 104a and third surface 106a together can in examples be considered together to constitute the top surface of the substrate 102.

In the examples of FIG. 2, the first axis 114 (also referred to as the horizontal axis 114) is substantially parallel (e.g. parallel within acceptable tolerances) to the plane of the first surface 104a. In these examples, the first joining surface 120a is non-orthogonal to the first surface 104a. In these examples, the third surface 106a is offset from the first surface 104a along the first axis 114 by an amount greater than a width 122 of the first surface 104a along the first axis 114. As referred to herein, the offset in a direction parallel to an axis is relative to a position along that axis where the edge of the entity in question lies (the edge which lies at the earliest position along that axis). For example, in FIG. 2, the edge of the first surface 104a lies at a position 124a along the first axis 114. It will be appreciated that a zero offset from the first surface 104a along the first axis 114 would mean that edges of each the first and the third surfaces 104a, 106a lie at the same position, the position 124a, along the first axis 114. In the examples of FIG. 2, the offset along the first axis 114 is such that the third surface 106a does not overlap the first surface 104a and the first joining surface 120a slopes in a vertical direction (with respect to the orientation of FIG. 2). In these examples, the position 126 along the first axis 114 at which the edge of the third surface 106a lies is a distance greater than the width 122 of the first surface 104a away from the position 124a.

A distance between opposite surfaces of the first cross-sectional structure is defined by horizontal positions 124a and 124b, which are points along the horizontal axis 114 . . . . The first waveguide layer 108 spans, relative to the horizontal axis 114, the horizontal positions 124a to 124b, and has a first external surface 144a with a horizontal position of 124a and a second external surface 144b with a horizontal position of 124b, the first and second external surfaces being opposite surfaces of the first waveguide layer 108. The second cladding layer 130 also spans, relative to the horizontal axis 114, the horizontal positions 124a to 124b.

In other words, the first waveguide layer 108 lies between horizontal positions 124a and 124b relative to the first axis 114, or all structure located vertically above the substrate 102 lies between horizontal positions 124a and 124b. In this sense, horizontal positions 124a and 124b define a first cross-sectional width 150 of the first cross-sectional structure, and define a distance relative to the horizontal axis 114 which is parallel to the substrate 102.

In the examples of FIG. 2, the first waveguide layer 108 comprises a first intermediate waveguide portion 128 in contact with the first and second joining surfaces 120a,b and between the first portion 110 and the second portion 112. In some examples, the substrate 102 with surfaces 104a, 106a offset in a direction parallel to the second axis 116 and a sloped joining surface 120a, as described, is at least partly formed before the first waveguide layer 108 on top of the substrate 102. In this manner, due to the sloped joining surface 120a, there is formed an intermediate portion of the waveguide at an angle corresponding to the angle of the joining surface 120a of the substrate. Thus, the first portion 110, the second portion 112 and the first intermediate waveguide portion 128 can in examples be considered together to constitute the first waveguide layer 108.

As described, in the examples of FIG. 2, the first portion 110 is in contact with the first surface 104a of the substrate 102. On the other hand, the second portion 112 is in contact with the third surface 106 which is offset in a direction parallel to the second axis 116 from the first surface 104a. This means that the first waveguide layer 108 comprises two portions which are offset from one another in a direction parallel to the second axis 116. As described, in these examples, the first waveguide layer 108 also comprises the first intermediate waveguide portion 128 which is at an angle relative to the second portion 112 and the first portion 110 as shown in FIG. 2.

FIG. 2 shows a polarisation converter 100 with a cross-sectional structure comprising portions offset in a direction parallel to the vertical axis 116 and a sloped surface relative to a surface of the cross-sectional structure. In other examples, described later, polarisation converters may comprise cross-sectional structures featuring offset portions in a direction parallel to the vertical axis 116 but no sloped surfaces, or polarisation converters may comprise cross-sectional structures featuring sloped surfaces but no offset portions. The provision of a polarisation converter with a cross-sectional structure comprising at least one of offset portions and/or sloped surfaces provides for conversion of the polarisation of light, as described in further detail below.

Because of the structure of the substrate 102 of FIG. 2 with a first surface and a second surface offset in a direction parallel to the vertical axis 116, the first waveguide layer 108 can be defined to have an arrangement for polarisation conversion without performing wet etching on the first waveguide layer 108, e.g. to define an angled side wall. For example, one or more materials for the first waveguide layer 108 can be epitaxially grown on the substrate 102, and because of the offset arrangement of the substrate 102, the first waveguide layer 108 with portions offset in a direction parallel to the vertical axis 116 is formed.

The first waveguide layer 108 comprises a material which has a higher refractive index than the material of the substrate 102. For example, the first waveguide layer 108 may comprise or be of Indium Gallium Arsenide Phosphide (InGaAsP). In other examples, though, the first waveguide layer 108 comprises or is of indium aluminium gallium arsenide (InAlGaAs), which for example has efficient electro-refractive properties. More generally, in some examples, the first waveguide layer 108 comprises (Al) InGaAs (P). The elements indicated in the parentheses can be interchangeable and the composition of the different elements is selected depending on the desired function. For example, the composition of Ga and As in InGaAs can be selected according to the desired bandgap. In some examples, the first waveguide layer 108 is a layer of (Al) InGaAs (P). In other examples, the first waveguide layer 108 comprises a plurality of sub-layers. In some such examples, the first waveguide layer 108 comprises a (Al) InGaAs (P)/(Al) InGaAs (P) multiple quantum well structure in contact with the substrate 102. In some examples, the sub-layers are between 5 and 30 nanometres thick. The sub-layer stack of the first waveguide layer 108 has a band gap selected in accordance with the desired application of the light polarisation converter 100.

The bandgap and therefore, as will be appreciated by those skilled in the art, the refractive index of the InGaAsP, for example, can be tuned. In some examples, the bandgap of the InGaAsP of the first waveguide layer 108 is tuned to a wavelength of 1250 nanometres (e.g. for propagation of light of wavelength 1550 nanometres) or 1100 nanometres (e.g. for propagation of light of wavelength 1310 nanometres). In other examples, the wavelength to which the bandgap is tuned is different.

The first waveguide layer 108 is for guiding light. Properties of a waveguide layer including, for example, its material refractive index and structural geometry, as well as properties of any surrounding cladding layers, restrict the spatial region in which light can propagate, for example, the first waveguide layer 108. The first waveguide layer 108 acts as a core layer, and has a refractive index higher than the refractive index of the surrounding cladding layer material, in this example the first cladding layer 130 and the substrate 102. The core-cladding boundary, in this case formed by the surfaces 106a,b 120a,b 104a,b which are in contact with the first waveguide layer 108 can be thought of as resulting in constructive interference of light which confines light to propagate within the first waveguide layer 108.

For example, particular optical modes of light are desired to propagate through the first waveguide layer 108 depending on the desired application of the light polarisation converter 100. The direction in which the optical modes propagate within the first waveguide layer 108 is herein referred to as the light propagation axis. The light propagation axis is parallel to the Poynting vector of light propagating in the waveguide and the negative vector of the Poynting vector. The light propagation axis is the general direction in which the energy of the optical mode travels through the waveguide 108. The term “modes” as used herein for example refers to optical modes, which may be considered to be electromagnetic propagation modes. The modes of a particular waveguide are described herein as being “supported” by the waveguide.

This arrangement of the first waveguide layer 108 provides for conversion of the polarisation of light. The following description is in the context of linearly polarised light incident on the first light polarisation converter 100 as indicated by the symbol 118, which indicates the first light propagation axis. However, it is to be appreciated that similar principles apply for light with a different polarisation.

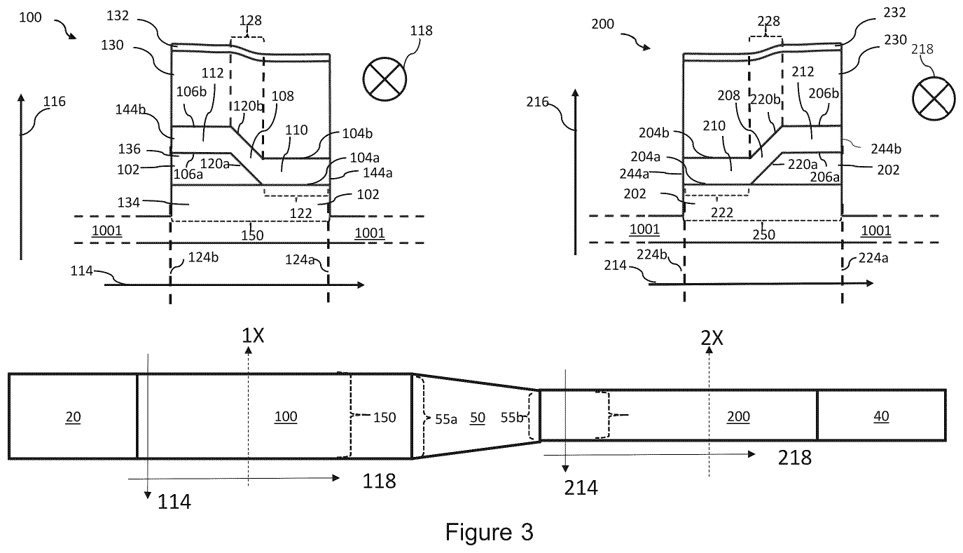

FIG. 3 illustrates schematically a top-down view of the light polarisation control device 10 of first examples, the cross-sectional structure of the first polarisation converter 100 as described in FIG. 2, and the cross-sectional structure of the second polarisation converter 200, which will now be described.

The second polarisation converter 200 has a second cross-sectional structure in a plane perpendicular to a second light propagation axis 218 (into the page, see symbol 218) of the second polarisation converter, the cross-section of the second polarisation converter 200 taken in a plane parallel to indicative line 2X. The cross-section of the first polarisation converter 100 is taken in a plane parallel to indicative line 1X. The cross-sectional structure of the first polarisation converter was described with respect to first axis 114 and second axis 116. The cross-sectional structure of the second polarisation converter 200 will hereafter be described with respect to a third axis 214 and fourth axis 216. The first axis 114 and the third axis 214 are, in FIG. 3, substantially parallel (within acceptable tolerances), with the first axis 114 being perpendicular to the first light propagation axis 118 and the third axis 214 being perpendicular to the second light propagation axis 218. In this example, the first light propagation axis 118 is parallel to the second light propagation axis 218. In other examples, the two polarisation converters may not lie parallel to one another, and so the first axis 114 and the third axis 214 may not be parallel, and the first light propagation axis 118 and the second light propagation axis 218 may not be parallel. However, within the cross-section of e.g. the first polarisation converter, the first axis is still perpendicular to the first light propagation axis 118, and e.g. the second polarisation converter, the third axis 214 is still perpendicular to the second light propagation axis 218.

The cross-sectional structure of the second light polarisation converter 200 comprises a second waveguide layer 208 between, and in contact with, a third cladding layer 230 and a fourth cladding layer, which in this example is the substrate 202. As for the first polarisation converter 100, here the second waveguide layer 208 acts as a core layer, and has a refractive index higher than the refractive index of the surrounding cladding layer material, in this example the third cladding layer 230 and the substrate 202, which is a fourth cladding layer. The second waveguide layer 208 can comprise a similar or the same material composition to the first waveguide layer 108.

The second waveguide layer 208 comprises a third portion 210 partially bounded by, and in contact with, fifth surface 204a of substrate 202 and sixth surface 204b of the third cladding layer 230, and a fourth portion 212 partially bounded by, and in contact with, a seventh surface 206a of the substrate and an eighth surface 206b of the first cladding layer 130. The fifth surface 204a, the sixth surface 204b, the seventh surface 206a, and the eighth surface 206b are parallel to each other.

The fifth surface 204a is offset from the seventh surface 206a along the third axis 214 and the fourth axis 216. The fifth surface 204a is connected to the seventh surface 206a by a third joining surface 220a of the substrate 202. The sixth surface 204b is offset from the eighth surface 206b along the third axis 214 and the fourth axis 216. The sixth surface 204b is connected to the eighth surface 206b by a fourth joining surface 220b of the third cladding layer 230. The fourth portion 212 is thereby offset from the third portion 210. The third axis 214 is perpendicular to the fourth axis 216. The third joining surface 220a is, in this example, substantially parallel (such as within acceptable fabrication tolerances) to the fourth joining surface 220b. The third joining surface 220a, fifth surface 204a and seventh surface 206a together can in examples be considered together to constitute the top surface of the substrate 202.

The third joining surface 220a and fourth joining surface 220b are sloped surfaces, similarly to the first joining surface 120a and second joining surface 120b of the first polarisation converter 100. The third joining surface 220a has an obtuse internal angle relative to the fifth surface 204a and seventh surface 206a. In other words, it is non-orthogonal to the fifth surface 204a or the seventh surface 206a. The fourth joining surface 220b has obtuse internal angles relative to the sixth surface 204b and the eighth surface 206b. In other words, it is non-orthogonal to the sixth surface 204b and the eighth surface 206b.

In FIG. 3, the second waveguide layer 208 comprises a second intermediate waveguide portion 228 in contact with the third and fourth joining surfaces 220a,b and between the third portion 210 and the fourth portion 212. In some examples, the substrate 202 with surfaces 204a, 206a offset in a direction parallel to the second axis 216 and a sloped joining surface 220a, as described, is at least partly formed before the second waveguide layer 208 on top of the substrate 202. In this manner, due to the sloped joining surface 220a, there is formed a second intermediate portion 228 of the second waveguide layer 208 at an angle corresponding to the angle of the joining surface 220a of the substrate. Thus, the third portion 210, the fourth portion 212 and the second intermediate waveguide portion 228 can in examples be considered together to constitute the second waveguide layer 208.

A distance between opposite surfaces of the first cross-sectional structure is defined by horizontal positions 224a and 224b, which are points along the horizontal axis 214. The first waveguide layer 208 spans, relative to the horizontal axis 214, the horizontal positions 224a to 224b, and has a first external surface 244a with a horizontal position of 224a and a second external surface 244b with a horizontal position of 224b, the first and second external surfaces being opposite surfaces of the first waveguide layer 208. The second cladding layer 230 also spans, relative to the horizontal axis 214, the horizontal positions 224a to 224b. In other words, the first waveguide layer 208 lies between horizontal positions 224a and 224b relative to the first axis 214, or all structure located vertically above the substrate 202 lies between horizontal positions 224a and 224b. In this sense, horizontal positions 224a and 224b define a first cross-sectional width 250 of the first cross-sectional structure, and define a distance relative to the horizontal axis 214 which is parallel to the substrate 202.

Whilst the first cross-sectional structure and the second cross-sectional structure are topologically similar, comprising similar overall structure, specific dimensions of constituent surfaces and features of the second cross-sectional structure are different to the first cross sectional structure of the first polarisation converter 100, as explained below.

In FIG. 3, the first cross-sectional structure has a first portion 110, which can be considered a lower portion, and a second portion 112, which can be considered a higher portion of the first cross-sectional structure, because the first portion 110 is lower with respect to the vertical axis 116 and the second portion 112 is higher with respect to the vertical axis 116. The lower portion 110 is further along the horizontal axis 114 than the upper portion 112. In the second cross-sectional structure, the upper portion 212 is located further along the horizontal axis 214 than the lower portion 210. In this way, the second intermediate portion 228 of the second waveguide layer 208 is angled in an opposite direction to the first intermediate portion 128 of the first waveguide layer 108. In other words, the first intermediate portion 128 can be considered to slope upwards (along vertical axis 116) in a right-to-left direction (opposite to horizontal axis 114), whereas the second intermediate portion 228 can be considered to slope upwards (along vertical axis 216) in a left-to-right direction (along horizontal axis 214) as shown in FIG. 3.

A width 222 of the fifth surface 204a and sixth surface 204b along the third axis 214 is shorter than the width 122 of the first surface 104a along the first axis 114. Likewise, a width (not labelled) of the seventh surface 206a and eighth surface 206b is shorter than the equivalent width of the third surface 106a and fourth surface 106b. A width of the first intermediate portion 128 along the first axis 114 is the same as a width of the second intermediate portion 228 along the third axis 214. The intermediate portions 128, 228 are the same width, but as described above, angled in opposite directions, and so the second intermediate portion 228 can be thought of as being a mirror image of the first intermediate portion 128. The first cross-sectional width 150 of the first polarisation converter in this example is therefore greater than the second cross-sectional width 250 of the second polarisation converter. However, this is merely an example.

The connecting waveguide 50 connects the first polarisation converter 100 to the second polarisation converter 200. In the example of polarisation control device 10, this connecting waveguide 50 is a planar waveguide with a waveguide layer at the same height (relative to the vertical axis 116) as the waveguide layers 110, 210 or 112, 212 of the polarisation converters. In other examples, the cross-sectional structure of the connecting waveguide 50 is similar to either the first cross-sectional structure of polarisation converter 100 or the second cross-sectional structure of polarisation converter 200. The connecting waveguide 50 has a cross-sectional width 55a,b which tapers from the first cross-sectional width 150, 55a to the second cross-sectional width 250, 55b. This can reduce loss from mode mismatch when coupling light from the first polarisation converter 100 to the second polarisation converter 200. In examples, the tapering of the connecting waveguide 50 can take the form of an adiabatic taper, which can reduce propagation loss through the connecting waveguide 50 by ensuring a suitably gradual and suitably shaped transition for propagation modes from a first waveguide width to a second waveguide width, as will be understood by those skilled in the art. Of course, the skilled person will appreciate that the first and second polarisation converters 100, 200 can, in examples, be butt-coupled together without a connecting waveguide 50.

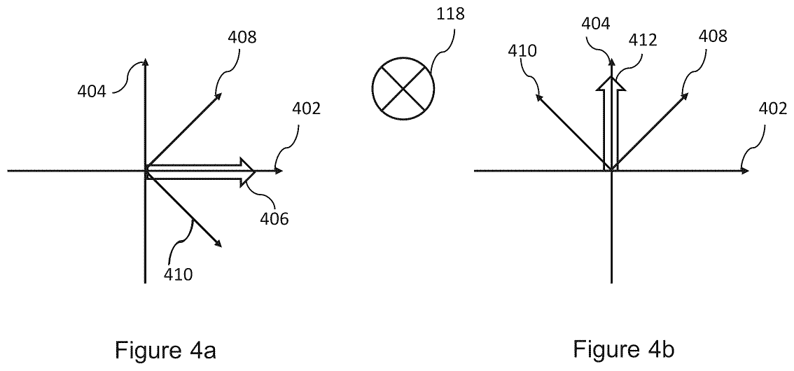

Referring now to FIGS. 4a and 4b, a function of the polarisation converters 100, 200 will now be described. The following description will be in the context of the first polarisation converter 100, but also describes a function of the second polarisation converter 200. FIG. 4a relates to input light and FIG. 4b relates to output light. Note that this is in the context of linearly polarised light incident on the polarisation converter 100 but it will be appreciated that similar principles apply to differently polarised light. FIGS. 4a and 4b illustrate a transverse electric (TE) polarisation axis 402 and a transverse magnetic (TM) polarisation axis 404. The light propagation axis 118 is, in FIGS. 4a and 4b, into the page (perpendicular to both the TE polarisation axis 402 and the TM polarisation axis 404). With respect to FIG. 2 or 3, the TM polarisation axis 404 is parallel to the first axis 116, and the TE polarisation axis 402 is parallel to the second axis 114.

For linearly polarised light, the direction of the electric field of light propagating as indicated by the first light propagation axis 118 can be indicated with respect to the TE polarisation axis 402 and the TM polarisation axis 404. The arrow 406 indicates linearly polarised light that is TE polarised. The cross-sectional structure of the polarisation converter 100 causes the modes supported by the polarisation converter 100 to be tilted relative to the polarisation axes 402, 404, meaning the modes supported by the polarisation converter 100 are hybrid modes. In the polarisation converter 100 having the form shown in FIGS. 2 and 3, the polarisation converter 100 having offset portions 110, 112 and sloped surfaces 120a, 120b provides boundary conditions for the light propagating within the waveguide which result in tilted modes.

The cross-sectional structure and resulting boundary conditions cause the polarisation converter 100 to support a first hybrid mode which has an electric field tilted with respect to the TE axis. The terms “tilt”, “angle” and “slope” are used interchangeably herein to refer to the angle of the first hybrid mode relative to the TE axis. The polarisation converter 100 also supports a second hybrid mode orthogonal to the first hybrid mode. In other words, the orientation of polarisation of the first hybrid mode is different to the orientation of polarisation of the second hybrid mode. A hybrid mode, as referred to herein, is a mode of light which has an electric field with a non-zero component along the TE polarisation axis and a non-zero component along the TM polarisation axis.

FIGS. 4A and 4B show a first hybrid mode 408 and a second hybrid mode 410. The first and second hybrid modes 408, 410 illustrate an example of hybrid modes that may exist within the polarisation converter when light is propagating therethrough. In this example, the first and second hybrid modes 408, 410 arise from light with TE polarisation (with the electric field along the TE polarisation axis 402), as shown by arrow 406, incident on the light polarisation converter for propagation through the polarisation converter.

The tilt angle (relative to the TE axis 402) for the first hybrid mode 408 is assumed to be 45 degrees. Such a tilt angle for the first hybrid mode 408 arises as a result of the arrangement of the polarisation converter 100, for example. In these examples, the angle with respect to the TE axis 402 of the second hybrid mode 410 is also 45 degrees and the first and second modes 408, 410 have electric fields with equal magnitude. Those skilled in the art will appreciate that the first and second modes 408, 410, with the tilt angle of 45 degrees and the phase relationship shown in FIG. 4a, have equal and opposite components along the TM polarisation axis 404 and in combination correspond to TE polarised light.

The second polarisation converter 200 also supports hybrid modes, supporting a third hybrid mode and a fourth hybrid mode, the third hybrid mode having a different orientation of polarisation to the fourth hybrid mode. Note that, as used herein, the second polarisation converter 200 supporting a third mode and a fourth mode does not necessarily mean that the polarisation converter 200 also supports a first and second mode-instead, “third” and “fourth” are labels to distinguish the modes of the first polarisation converter from the second polarisation converter, rather than to imply e.g specific support for a number of higher-order modes.

The second polarisation converter 200 having a second cross-sectional structure different to the first cross-sectional structure of the first polarisation converter 100, means the third and fourth hybrid modes have different tilt angles, or, in other words, different orientations of polarisation, to the first and second hybrid modes of the first polarisation converter 100. The tilt angles for the third and fourth hybrid modes supported by the second polarisation converter 200 are determined by the arrangement of the second cross-sectional structure. For example, the angle of the third mode might be 22.5 degrees relative to the TE mode and the fourth mode might be −67.5 degrees.

The tilt angle of the modes supported by a polarisation converter has a dependency upon the cross-sectional width of the cross-sectional structure of the polarisation converter. In this way, two substantially identical (within acceptable tolerances) polarisation converters can be initially fabricated, and a cross-sectional width of a second polarisation converter of the pair reduced, e.g. by lithography and/or etching, relative to a cross-sectional width of a first polarisation converter of the pair to thereby result in the modes supported by the second polarisation converter having different tilt angles to the modes supported by the first polarisation converter. This principle readily extends to initially fabricating more than two Polarisation converters, and etching respective widths. Having a plurality of converters each supporting different tilt angles can help the polarisation control device 10 access a greater region of, or the whole, Poincaré sphere, as explained in more detail later.

Furthermore, the described arrangement of cross-sectional structures of the polarisation converters 100, 200 has a different propagation constant for the first and second hybrid modes 408, 410 of the first polarisation converter. The arrangement results in birefringence such that the first and second hybrid modes 408, 410 experience different effective refractive indices to one another when propagating within the polarisation converter. An effective refractive index of a waveguide is a dimensionless number that describes how fast light of a particular mode travels through a waveguide and how light attenuates through the waveguide. A refractive index of a material is a dimensionless number that describes a phase velocity of a light wave in the material and how light attenuates through the material. Effective refractive index and refractive index are commonly expressed as a complex number; however, herein only the real component of refractive index is considered. The real component of a refractive index is the speed of light in vacuum divided by the phase velocity of the light wave in the material. In some examples, effective refractive index and/or refractive index is dependent on the wavelength of the light being considered. Herein when a comparison is made between two effective refractive indices or between to two refractive indices, the comparison is between the real components for the same wavelength of light.

This means that the phase difference between the first and second hybrid modes 408, 410 changes as the first and second hybrid modes 408, 410 propagate. In other words, the phases of the first and second modes 408, 410 evolve differently as the first and second modes 408, 410 propagate within the polarisation converter, with the phase of light in one mode changing more quickly than the phase of light in the other mode. As the skilled person will appreciate, this description also applies to the third and fourth mode of the second polarisation converter 200.

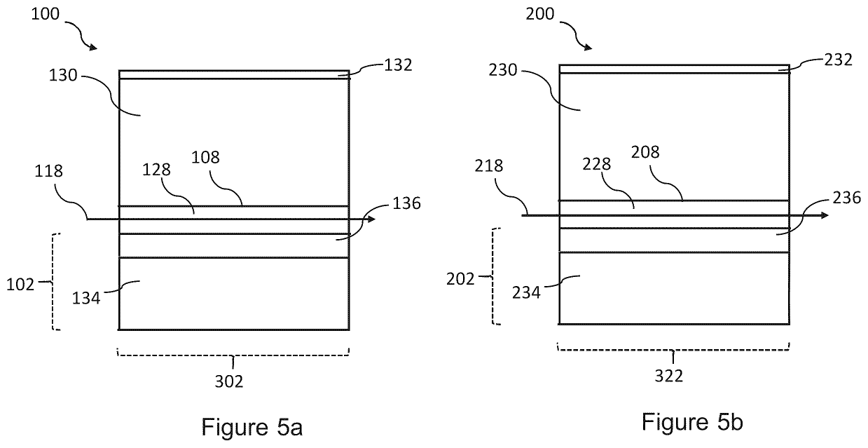

FIGS. 5a and 5b illustrate schematically side cross-sections taken on planes parallel the first and second LPAs 118, 218 of the polarisation converters 100, 200 of FIG. 3. The first polarisation converter 100 has a length 302 parallel to the first light propagation axis 118. Similarly, the second polarisation converter 200 has a length 322 parallel to the second light propagation axis 218.

As light in the first and second hybrid modes propagates along the first polarisation converter 100 with the respective propagation constants, there is a resulting phase difference between the first and second hybrid modes. The length of the first polarisation converter 100 therefore determines, for fixed respective propagation constants, the phase difference between the first and second mode after propagation through the first polarisation converter 100. More generally, the optical path length of the first polarisation converter 100 determines the phase difference accrued between the first and second modes after propagation through the first polarisation converter 100.

Consider an input waveguide providing TE light 406 to the first polarisation converter 100. The first hybrid mode 408 and second hybrid mode 410 are excited with a relative phase difference of zero. Light in these modes propagates along the first polarisation converter 100 for a length 302 which results in a relative phase difference of x, as seen by the position of the second hybrid mode 410 in FIG. 4b. In FIG. 4b, the first hybrid mode 408 and the second hybrid mode 410 would excite, in an output waveguide, the TM light 412. In this way, the accrual of a phase difference between the first and second hybrid modes 408, 410 has rotated an input TE mode 406 to an output TM mode 404. At a phase difference of x radians (and integer multiples thereof), for example, the modes are out-of-phase. At a phase difference of 2x radians (and integer multiples thereof), the modes are in phase. A length 302 of the first polarisation converter 100 for the phase of the modes of light propagating therein to be restored is referred to as the beat length. For example, if the first and second modes start their propagation within the first polarisation converter 100 in phase, the modes will be back in phase after propagating an integer multiple of the beat length within the first polarisation converter 100.

As discussed above, the described arrangement of the first polarisation converter 100 causes a different propagation constant for the first and second hybrid modes. The described arrangement of the first polarisation converter 100 (with the described cross-sectional structure), causes there to be birefringence in that the first and second hybrid modes experience a different effective refractive index to one another. The propagation constant of the first hybrid mode in the first polarisation converter 100 can be represented by β₁ and the propagation constant of the second hybrid mode can be represented by β₂. The difference in these propagation constants can be represented as Δβ=β₁-β₂ . . . . Those skilled in the art will appreciate that β represents phase propagation, that is:

$$β = {n}_{eff} \frac{2 π}{λ} \qquad ( 1 )$$

where λ is a given wavelength and neff the effective refractive index of a mode of light of the given wavelength.

Equation 1 below shows the beat length L_{λ} for the first polarisation converter 100 for the first and second hybrid modes In Equation (2) below, λ is the given wavelength and Δn represents the difference in the effective refractive indices of the first and second hybrid modes: Δn=n₁-n₂.

$${L}_{λ} = \frac{2 π}{Δβ} = \frac{λ}{Δ n} \qquad ( 2 )$$

In some examples, the beat length is affected by the thickness and/or the cladding of the first polarisation converter. In some examples, the first polarisation converter is curved, and consequently the light propagation axis is curved, and the beat length is taken along a curve. In these examples, where the first hybrid mode 408 has a 45 degree angle relative to the TE axis 402, by selecting the length of the first polarisation converter 100 to be an odd integer multiplied by half of the beat length, linear polarisation of the given wavelength of light can be rotated as described above. For example, a first linear polarisation (TE polarisation in the above examples) can be converted to a second linear polarisation (TM polarisation in the above examples). The control of phase is the basis for a polarisation converter, or rotator, as will be understood by those skilled in the art. As will be appreciated, the second polarisation converter 200 shown in FIG. 5b can control the phase of light in a similar manner to the first polarisation converter 100 of FIG. 5a.

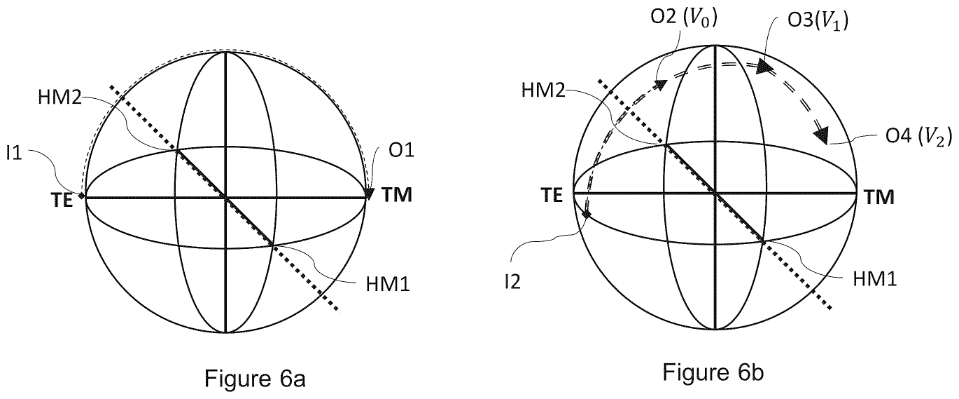

FIG. 6a is a sketch of the Poincaré sphere. Those skilled in the art will appreciate that all polarisation states can be mapped onto the surface of the so-called Poincaré sphere. Points lying on the equator of the Poincaré sphere represent all angles of linear polarisation. The poles of the Poincaré sphere represent clockwise and anticlockwise circular polarisations. The points corresponding to TE polarisation and TM polarisation can be seen in FIG. 6a.

Points corresponding to the first (HM1) and second (HM2) hybrid modes lie on the equator of the Poincaré sphere, labelled in FIG. 6a as HM1 and HM2. The position of the hybrid modes on the equator depends on the tilt, in other words the angle, of the first hybrid mode relative to the TE axis.

In the case of the first hybrid mode having a 45-degree angle relative to the TE axis, the first hybrid mode corresponds to point HM1 and the second hybrid mode corresponds to the point HM2. Δn axis crossing HM1 and HM2 is perpendicular to an axis crossing the TE and TM polarisation points on the equator of the Poincaré sphere. Propagation of the hybrid modes through the polarisation converter, where their phases evolve differently from one another, corresponds to rotation of a point that represents the polarisation when the hybrid modes recombine, about the axis crossing HM1 and HM2. A 180-degree rotation about an axis crossing HM1 and HM2 leads to e.g. polarisation conversion from TE polarisation to TM polarisation, wherein half a circumference of the Poincaré sphere is traversed. This corresponds to e.g. the optical length of the polarisation converter being half a beat length.

FIG. 6b illustrates, for a polarisation converter, the effect of active control of the effective refractive indices of the modes on the state of polarisation accessible by the polarisation converter, the active control achieved using at least one control element such as an electrical contact layer (e.g. the electrical contact layer 132 in the first polarisation converter 100). The electrical contact layer 132 is configured to receive a control signal, the control signal determining the value of e.g. a positive voltage to be applied to the polarisation converter by carrier injection, or e.g. a negative voltage applied by carrier depletion, where the choice of carrier injection or depletion is dependent upon the material composition and structure of the polarisation converter. The voltage, which can be referred to as a potential difference, is applied between the electrical contact layer 132 and the substrate of the photonic integrated circuit.

Application of a voltage and carrier injection/depletion to a polarisation converter such as any of the polarisation converters of the examples herein can produce a change in the effective refractive indices of the modes supported by the polarisation converter. The effective refractive index of the first mode may change by the same amount as the effective refractive index of the second mode. In such a case, the birefringence is unaltered, and the optical length of the polarisation converter is changed by the same amount for both modes. Alternatively, the effective refractive index of the first mode may change by a different amount to the effective refractive index of the second mode. In this case, the birefringence of the polarisation converter is modified by the control element. This changes the optical length of the polarisation converter for the first mode by a different amount than the optical length of the second mode. In either case, the phase-difference accrued between the two modes can be controlled. The specific way in which the phase-difference is accrued will depend on the system, such as the material composition and the cross-sectional structure of the polarisation converter.

In the example of FIG. 6b, with no voltage (V₀) applied to the polarisation converter by an electrical contact layer, an input state of light 12 is rotated about the axis crossing HM1 and HM2 to an output polarisation state of light O2. When there is a change in the applied voltage to a voltage V₁, the effective refractive indices of the first and second modes change such that the phase difference accrues more quickly between the first and second mode, meaning that the polarisation of the input light is changed to an output state O3, traversing a greater portion of the Poincaré sphere from the input 12 than that traversed to reach the state of polarisation of output O2. When a voltage V₂, V₂ >V1 is applied, an even greater portion of the Poincaré sphere is traversed, as the state of polarisation of input state 12 is modified to output a state of polarisation 04. Active control of the polarisation converter in this way allows for the change of polarisation state, as a rotation about the rotational axis defined by hybrid mode tilt angles HM1, HM2, to be controlled and selected using a single polarisation converter.

A polarisation converter of a polarisation control device having a length corresponding to a quarter of a beat length means that the polarisation converter passively produces a change to a polarisation state spanning a quarter of the circumference of the Poincaré sphere-that is, without actively applying an electrical field across the polarisation converter, the polarisation state is modified by this amount. . . . The passive effect of the polarisation converter will produce a first phase-difference, and active control effects resulting from application of an electric field will produce a second phase-difference which may add to the first phase-difference or reduce the first phase-difference. It can be useful for a polarisation converter to have a propagation length which is sufficiently long that the active control of the polarisation converter can change the optical length of the polarisation converter by e.g. half a beat length to thereby change the polarisation state by half the Poincaré sphere. As a result, a polarisation converter of the polarisation control device may be multiple beat lengths long to enable this degree of active polarisation control.

Increasing the birefringence of a polarisation converter, and the change to birefringence induced by an applied voltage, can reduce the physical length of the polarisation converter required to obtain a desired phase difference (understood by a reduction in the beat length as per Equation 2), which can decrease the overall spatial footprint of the device. Increased birefringence can be achieved by provision of e.g. a multiple quantum well structure in the waveguide layer of the polarisation converter, for example, which in some examples may be sensitive to the quantum-confined Stark effect which is highly polarisation sensitive.

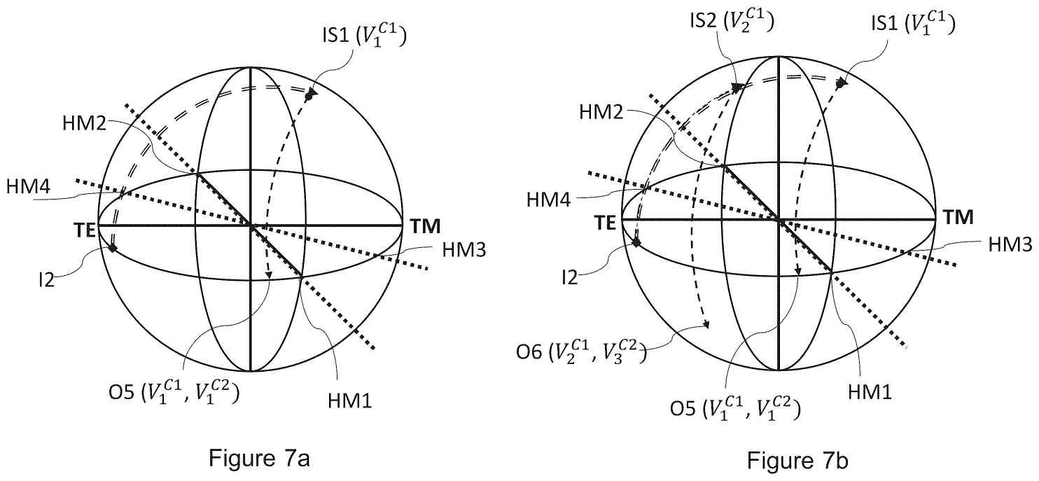

FIGS. 7a and 7b illustrate the control afforded by two polarisation converters e.g. the first and second polarisation converters 100, 200 shown in FIGS. 2 and 3, arranged in series as part of a polarisation control device 10 described herein.

As described above, in examples, the first polarisation converter 100 supports a first mode with a 45-degree tilt angle and a second mode orthogonal to the first mode, thereby defining a first axis of rotation through the Poincaré sphere defined by HM1, HM2. In examples, the second polarisation converter 200 supports a third mode HM3 and a fourth mode HM4 which have different tilt angles to the first and second mode. The third and fourth modes HM3, HM4 define a second axis of rotation through the Poincaré sphere defined by HM3, HM4. Δn input state can access a greater region of the Poincaré sphere by provision of two axes of rotation, compared with just one axis of rotation.

The input state 12 has an initial state of polarisation. The input state 12 is input into the first polarisation converter 100, whereupon the acquisition of a phase difference between the first and second mode results in a rotation about the first rotational axis HM1, HM2 to produce an intermediate state of polarisation IS1, the state of light at the output of the first polarisation converter 100. A voltage V₁ is applied to the first polarisation converter 100 —that is, intermediate state IS1 is reached under the condition V₁^{C1}, a voltage V₁ applied to the first polarisation converter 100. Intermediate state IS1 is then coupled into third and fourth modes of second polarisation converter 200, whereupon acquisition of a phase difference between the third and fourth mode results in a rotation about the second rotational axis HM3, HM4 to arrive at an output state O5 which in this case is a linear polarisation. A voltage V₁ is applied to the second polarisation converter 200—that is, output state O5 is reached under the condition V₁^{C1}, V₁^{C2}, a voltage V₁ applied to the first polarisation converter 100 and a voltage V₁ applied to the second polarisation converter 200. Voltages can be applied to the first and second polarisation converters 100, 200 using at least one control element, which may include an electrical contact layer. Separate control element(s) may be used to control the first and second polarisation converters 100, 200 or a common control element or plurality of control elements may be used to control both the first and second polarisation converters 100, 200.

In FIG. 7b, a voltage V₂ is applied across the first polarisation converter 100 and a voltage V₃ is applied across the second polarisation converter 200. The input state 12 is coupled into the first and second mode of the first polarisation converter 100 and, after propagation through the first polarisation converter 100 and accrual of a phase difference as described previously, modified to an intermediate state of polarisation IS2, where IS2 is reached under condition V₂^{C1}, V₂^{C1} indicating a voltage V₂ applied to the first polarisation converter 100. The intermediate state IS2 is then coupled into the third and fourth mode of the second polarisation converter 200 and, after propagation through the second polarisation converter 200, modified to output state 06, reached under condition V₂^{C1}, V₃^{C2}, where a voltage V₂ has been applied across the first polarisation converter 100 and a voltage V₃ has been applied across the second polarisation converter 200, where V₃>V₁>V₂.

In this way, different states of polarisation of an output state can be achieved for an input state by modifying the voltage applied across the first and second polarisation converters 100, 200 of the polarisation control device 10. The precise values for the voltages applied to the first and second polarisation converters, including whether the voltages are positive or negative, and the resulting change to the refractive indices and birefringence which determines the rotation about the Poincare sphere, will depend on the precise electro-optical properties of the polarisation converters being used.

By randomly varying the voltage applied to each of the first and second polarisation converter 100, 200 such that the induced phase-difference between the first and second mode, and the third and fourth mode, is randomly varied with time, the output of polarisation can be made to randomly vary with time, or in other words scrambled, thereby enabling the polarisation control device 10 to function as a polarisation scrambler. If, for example, a portion of the output light is measured, for example by weakly coupling a portion of the output mode into a separate measurement arm of the PIC, then the polarisation state of the output can be monitored. Such a measurement arm may comprise a polarisation-dependent photodetector, or use of polarisation filtering, in order to establish the polarisation state of the output. Control of the polarisation control device 10 can thereby be configured to enable arbitrary input polarisation states to be modified to a known output polarisation, enabling the polarisation control device 10 to function as a polarisation controller. By receiving appropriate control signals at the at least one control element, the polarisation control device 10 can be used as a polarisation scrambler or a polarisation controller. In other words, by modifying the control signal provided to the polarisation control device, the same combination of components can be used to realise a plurality of different functions, such as the functionality of a polarisation controller and/or a polarisation scrambler. The polarisation control device 10 may be provided with control signals from an external control system, or the polarisation control device 10 may include appropriate control circuitry to provide the control signals to the at least one control element.

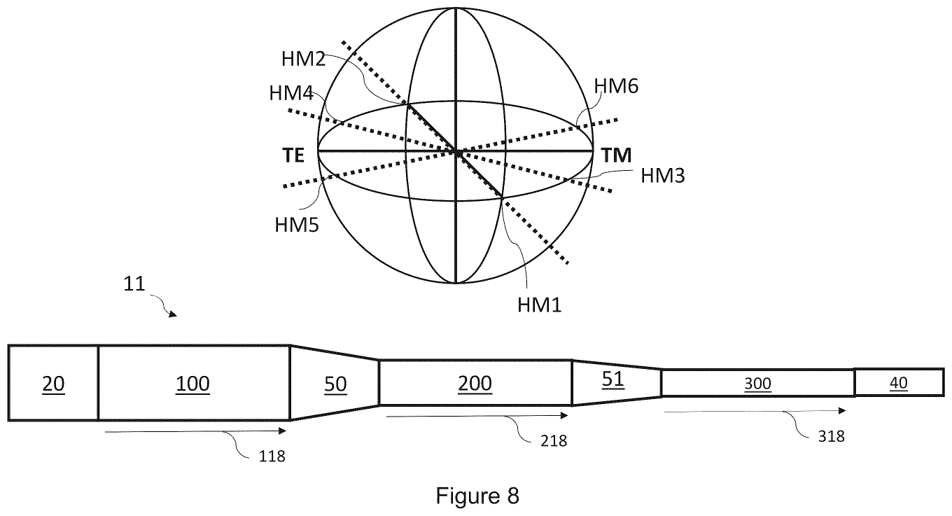

FIG. 8 illustrates schematically a polarisation control device 11 according to examples, and a Poincaré sphere illustrating the polarisation rotation axes of the polarisation control device 11The polarisation control device 11 comprises an input waveguide 20. In addition, the polarisation control device 11 includes a first polarisation converter 100, a first connecting waveguide 50, and a second polarisation converter 200 arranged in series which are the same as the first polarisation converter 100, the first connecting waveguide 50 and the second polarisation converter 200 of the polarisation control device 10 described previously with reference to FIGS. 2 and 3. The polarisation control device 11 of FIG. 8 additionally comprises a second connecting waveguide 51, a third polarisation converter 300 and an output waveguide 40 also arranged in series with the above features. The second connecting waveguide 51 is configured to receive light from the second polarisation converter 200 and to provide light to the third polarisation converter 300. The light polarisation converter 300 is configured to provide light received from the second connecting waveguide 51 to the output waveguide 40.

The function and form of the third polarisation converter 300 in examples is substantially similar to or the same as the first and second polarisation converters 100, 200. Substantially similar, in this context, means that the structure differs only in the ways described hereafter, and the function within the context of polarisation control will be understood by the person skilled in the art to be the same as the first and second polarisation converters. The third polarisation converter 300 supports a fifth mode and a sixth mode and comprises a third cross-sectional structure (not pictured) in a plane perpendicular to a third light propagation axis 318 which determines the tilt angles, or orientations of polarisation, of the fifth mode and the sixth mode, the tilt angle of the fifth mode being different to the tilt angle of the sixth mode.

The third cross-sectional structure is different to the first cross sectional structure and the second cross-sectional structure, such that the fifth mode and the sixth mode have different orientations of polarisation to the first mode and the second mode, and different orientations of polarisation to the third mode and fourth mode. In the example of FIG. 8, the third cross-sectional structure is similar to the second cross-sectional structure in that the third cross-sectional structure comprises a third intermediate portion sloped in the same direction (i.e. sloping upwards left-to-right) as the second intermediate portion of the second cross-sectional structure, but a third cross-sectional width of the third polarisation converter 300 is smaller than the second cross-sectional width of the second polarisation converter 200, which results in the fifth and sixth mode having different orientations of polarisation to the third and fourth mode, and also to the first and second mode. In other examples, the third cross-sectional structure could comprise an intermediate portion which slopes in the same direction as the first intermediate portion of the first cross-sectional structure such that the fifth and sixth mode have different orientations of polarisation to the third and fourth mode, and first and second mode.

In further examples, all three polarisation converters comprise intermediate portions sloping the in same direction, and different respective cross-sectional widths alone provide different tilt angles of the supported modes.

The third polarisation converter 300 is birefringent, so the fifth mode has a higher effective refractive index than the sixth mode. The third polarisation converter 300 has a control element, which in this example is an electrical contact layer, which is configured to, responsive to a signal, modify the effective refractive indices of the fifth mode and the sixth mode by applying a voltage across the third polarisation converter 300.

Considering the Poincaré sphere, the third polarisation converter 300 defines a third rotational axis through the fifth and sixth hybrid modes HM5, HM6. This can further enhance the range of positions on the sphere, i.e. the range of polarisation states accessible by the polarisation control device 11. It can also improve the flexibility of the device in achieving a given output polarisation state by providing another control degree of freedom. Different paths across the Poincaré sphere can be taken, using this additional degree of freedom, to a given output state.

The third polarisation converter 300 in this example supports modes with different orientations of polarisation to modes supported by the first and second polarisation converters 100, 200, but in other examples a polarisation converter device may instead include a third polarisation converter that is identical toa first polarisation converter, and permit a rotation about the same rotational axis. For example, a polarisation control device comprising a combination of polarisation converters with tilt angles of 30-degrees, 60-degrees and 30-degrees relative to e.g. TE modes can permit polarisation conversion from arbitrary input to arbitrary output polarisations. In other examples, a polarisation control device comprising a first polarisation converter having tilt angles between 20-40 degrees, for example 30 degrees, a second polarisation converter having 0-degree tilt angles (i.e. modes aligned to the TE/TM mode of the photonic integrated circuit), and a third polarisation converter having tilt angles between 50-70 degrees, for example 60 degrees, may be suitable.

In yet further examples, a 0-degree, 45-degree, 0-degree arrangement may be suitable. In such a scheme, the first polarisation converter (0-degrees) acts as a phase-shifter to TE/TM input states (and so for TE/TM input states may not be required), the second polarisation converter (45-degrees) rotates the polarisation away from TE/TM, and the third polarisation converter (0-degrees) accesses the remainder of the sphere.

Additionally, having multiple polarisation converters with redundancy between rotations offered by the polarisation converters may enable lower voltages to be applied to any individual section, if the effect of providing multiple polarisation converters is to increase the overall optical length of polarisation converters.

In yet further examples, the polarisation control device may comprise, as part of the series, a polarisation converter, or multiple polarisation converters, which lacks active control preceding, interposed between, or following the polarisation converters with active control.

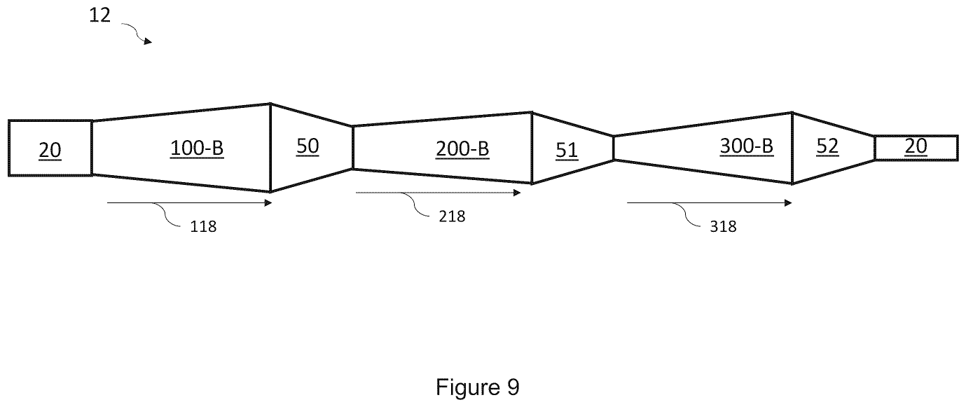

FIG. 9 schematically illustrates a polarisation control device 12 which comprises first, second and third polarisation converters 100-β, 200-β, 300B. The first polarisation converter 100-B has a first cross-sectional width (the width being the total width of the first cross-sectional structure, as described previously) which varies along a length of the first polarisation converter, the length being parallel to a first light propagation axis 118 of the first polarisation converter. Similarly, the second polarisation converter 200-B has a cross-sectional width which varies along a length of the second polarisation converter and the third polarisation control device 300-B has a third cross-sectional width which varies along a length of the third polarisation converter, the respective lengths lying parallel to respective light propagation axes 218, 318 of the respective polarisation converters.

The birefringence of a polarisation converter can be dependent on the voltage applied across the converter. In such a case, modification of the voltage applied to a converter does not result in the polarisation state undergoing an equatorial rotation about a rotational axis, as the accrual of phase difference is not linear with voltage. Instead, the curvature the polarisation state traces will drift. This can result in non-trivial control dynamics. Varying the cross-sectional width of each polarisation converter can introduce a birefringence which depends on propagation length within the polarisation converter. That is, at a first propagation distance within, for example, the first polarisation converter there is a first birefringence between the first and second mode, and at a second propagation distance within the first polarisation converter there is a second birefringence between the first and second mode, which is different from the first birefringence. This can be used to reduce or counteract the effect of non-linear voltage-dependent birefringence of the polarisation converter, simplifying the control dynamics and/or increasing the accuracy of polarisation control.

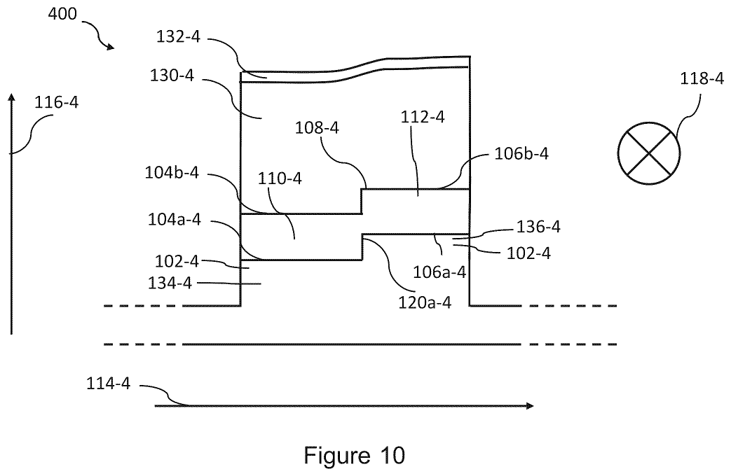

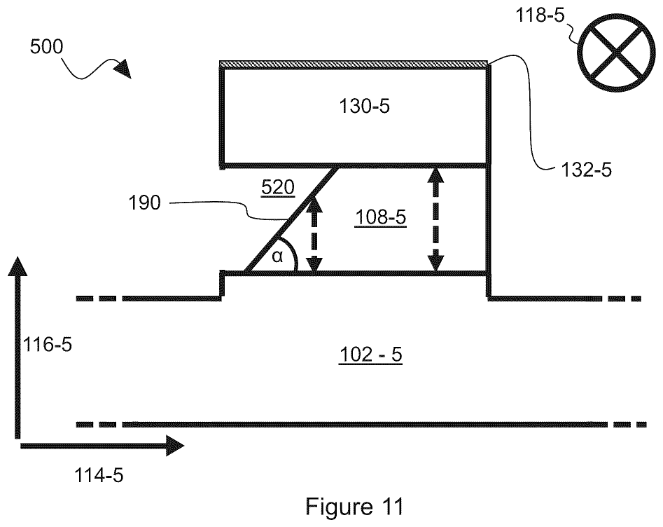

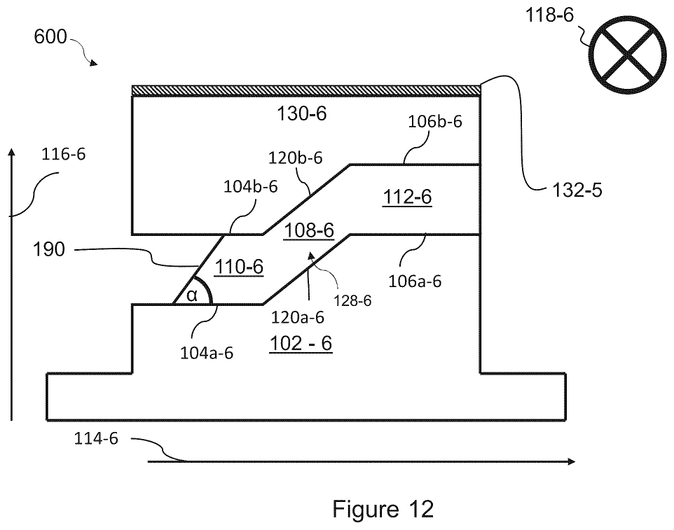

FIGS. 10 to 12 illustrate further examples of cross-sectional structures of polarisation converters, the geometries of which can realise tilted mode angles. Polarisation converters in other examples of the polarisation control device described herein may feature the cross-sectional structure of any the described examples of polarisation converters in any combination. For example, a first cross-sectional structure of a first polarisation converter of a polarisation control device may be according to e.g. FIG. 2, whereas a second cross-sectional structure of a second polarisation converter of the polarisation control device may be according to e.g. FIG. 10, or FIG. 11, or FIG. 12, or some variation thereof.

Additionally, the orientation of features of the cross-sectional geometries of each polarisation converter which provide for the tilted boundary conditions and hence tilted mode angles e.g. tilted intermediate portions of examples of FIGS. 1-3, can be chosen according to the desired polarisation control of the polarisation control device. In the examples of FIGS. 1-3, the first polarisation converter 100 has a first intermediate portion 128 which slopes upwards right-to-left, and the second polarisation converter 200 has an intermediate portion 228 which slopes upwards left-to-right. In other examples, the first intermediate portion 128 may slope in the same direction as the second intermediate portion 228 (i.e. both sloping upwards left-to-right, or both sloping upwards right-to-left, relative to respective horizontal axes), and the mode tilt angles of the first polarisation converter can be made different to the second polarisation converter if the first polarisation converter has a different cross-sectional width to the second polarisation converter.

FIG. 10 illustrates schematically a side cross-section of a light polarisation converter 400 according to examples. In FIG. 10, features corresponding to those shown in FIG. 2 are labelled with similar reference numerals with the additional numeral “−4” added at the end (with the except of the light polarisation converter itself, which is labelled with the reference numeral 400).

The polarisation converter 400 has a cross-sectional structure, described here with respect to vertical axis 116-4 and horizontal axis 114-4, each perpendicular a light propagation direction 118-4 through the polarisation convertor 400, the vertical axis 116-4 perpendicular to the horizontal axis 114-4.

The light polarisation converter 400 of FIG. 10 corresponds to the first light polarisation converter 100 (and may comprise any combination of the features described above in relation to the first light polarisation converter 100), except for the following differences.

The first joining surface 120a-4 of the light polarisation converter 400 of FIG. 10 is substantially at a 90 degree angle (within acceptable tolerances) relative to the first surface 104a-4 and third surface 106a-4 of FIG. 10. In these examples, the first joining surface 120-4 corresponds to a side wall of a second substrate layer 136-4 of FIG. 10. Similarly, the second joining surface 120b-4 is substantially at a 90-degree angle relative to the second surface 104b-4 and fourth surface 106b-4 of FIG. 10.

As a consequence of the angle of first and second joining surfaces 120a,b-4 in these examples, the light polarisation converter 400 of FIG. 10 does not comprise an intermediate portion. In the example of FIG. 10, the first portion 110-4 is continuous with the second portion 112-4 instead of having an intermediate, sloped portion therebetween. As in the case of the examples of FIGS. 2 and 3, the waveguide layer 108-4 of the light polarisation converter 400 is a single waveguide layer for propagation of light.

The waveguide layer 108-4 of FIG. 10 comprises the second portion 112-4 offset relative to the first portion 110-4 in a direction parallel to the second axis 116-4, and continuous with the first portion 110-4 as shown in FIG. 10.

The cross-sectional structure of the polarisation converter 400 of FIG. 10 causes it to support hybrid modes. Similarly to the cross-sectional structure of the polarisation converter examples of FIGS. 2 and 3, this arrangement of the cross-sectional structure of the polarisation converter 400 of FIG. 10 provides a “tilted” or sloped boundary condition for the light propagating within the waveguide layer 108-4, providing for the hybrid modes. This is because, light propagating within the polarisation converter 400 occupies waveguide layer regions continuous with one another that are offset in a direction parallel to the second axis 116-4. In addition, the described cross-sectional structure of the polarisation converter 400 causes a different propagation constant for different hybrid modes. The described cross-sectional structure including the waveguide layer 108-4 provides birefringence such that the first and second hybrid modes experience different refractive indices to one another within the polarisation converter 400 of FIG. 10. For example, for light with TE polarisation as shown by arrow 206 of FIG. 4a incident on the light polarisation converter 400 of FIG. 10 for propagation through the waveguide layer 108-4, the first and second hybrid modes 408, 410 arise with different propagation constants (and consequently different phase evolution).

Both the cross-sectional structures of the polarisation converter 400 of FIG. 10 and the first polarisation converter 100 give rise to hybrid modes and a different propagation constant for the hybrid modes. As described above, the presence of the hybrid modes and their different propagation constants provide for conversion of the polarisation of light. Therefore, similarly to the first light polarisation converter 100 of the examples of FIG. 2, the light polarisation converter 400 of the examples of FIG. 10 can be used to convert the polarisation of incident light. Δn electrical contact layer 132-4, as described in previous examples, is used to apply a voltage and thereby achieve active control of the polarisation rotation performed by the polarisation converter 400 of FIG. 10.

The examples of FIGS. 2 and 3 or the examples of FIG. 10 may be used depending on various factors such as complexity and cost of manufacturing and the desired level of control over the hybrid modes and their propagation constants. For example, the presence of the intermediate waveguide portion 128 of the examples of FIGS. 2 and 3 being at angle (sloped) provides finer tuning of the characteristics (such as tilt) of the hybrid modes. However, the examples of FIG. 10 may be simpler to manufacture as the stepped structure of the polarisation converter 400 obviates the need to manufacture a polarisation converter with a sloped surface.

FIG. 11 schematically illustrates a polarisation converter 500 according to examples. The polarisation converter 500 has a cross-sectional structure, described here with respect to vertical axis 116-5 and horizontal axis 114-5, each perpendicular a light propagation direction 118-5 through the polarisation convertor 500, the vertical axis 116-5 perpendicular to the horizontal axis 114-5. The polarisation converter 500 of FIG. 11 includes a first waveguide layer 108-5 between a substrate 102-5 (which may be considered to be a first cladding layer) and a second cladding layer 130-5. In the cross-sectional structure of the polarisation converter 500 of FIG. 11, an orientation of the first waveguide layer 108-5 can be set in accordance with desired polarisation conversion properties. The waveguide layer 108-5 can be considered to tilt or slope, for example by an internal angle α taken relative to the substrate 102-5, or (180°-α) relative to the second cladding layer 130-5. Hence with the waveguide layer 108-5 being angled in this way, differently from the first cladding layer (which in this example corresponds to the substrate 102-5) or the second cladding layer 130-5, the waveguide layer 108-5 is for example non-parallel the substrate 102-5. For example, a sloped surface 190 of the waveguide layer is angled relative to the substrate 102-5 by the internal angle α of 30 to 65 degrees, for example, and depending on a plane of a crystalline material, 30 to 40 degrees, such as approximately 35 degrees (within acceptable manufacturing tolerances), or 50 to 65 degrees, such as approximately 55 degrees or 60 degrees (within acceptable manufacturing tolerances), 50 to 55, 55 to 60 or 60 to 65 degrees and/or the second surface is angled relative to the third surface by an internal angle β of approximately 90 degrees within acceptable manufacturing tolerances. The third surface is for example substantially parallel the fourth surface (e.g. parallel within acceptable manufacturing tolerances).

The material of which the waveguide layer 108-5 is formed is for example a crystalline material, with the angle of the first angled surface corresponding with a {111} plane of the crystalline material. The {111} notation is in accordance with the Miller index system for indicating a plane or family of planes in a crystal, as will be known to the skilled person. Such a plane may also be referred to as a crystal plane. By using an appropriate manufacturing method, e.g. with a particular etchant selective for a particular crystal plane, the angle of the first angled surface can be simply obtained.

Such an etching approach is selective so as to etch the material of the waveguide layer 108-5 without etching (or notably more slowly etching) the material forming the first and second cladding layers. Hence, to form the first angled surface 190, waveguide layer material is removed during the etching from between the first and second cladding layers, e.g. from under the second cladding layer. In examples there is therefore a region 520 between the first and second cladding layers 102-5, 130-5 where the waveguide layer 108-5 is not present.

With the first angled surface 190 of the waveguide layer 108-5 angled in this way, the polarisation converter 500 of FIG. 1 supports tilted modes. The internal angle α can be selected to determine the orientation of polarisation of the supported modes. The polarisation converter 500 is birefringent, such that a first mode of the supported hybrid modes has a higher effective refractive index than a second mode of the supported hybrid modes. The cross-sectional structure displayed in FIG. 11, formed, for example, by use of an under-etching technique, can therefore be arranged to provide for a polarisation converter for use in the polarisation control devices described herein. Δn electrical contact layer, 132-5, enables active control over the polarisation rotation achieved by polarisation converter 500.

FIG. 12 features a polarisation converter 600 according to examples. In FIG. 12 features corresponding to those shown in FIG. 2 are labelled with similar reference numerals with the additional numeral “−6” added at the end (with the exception of the light polarisation converter itself, which is labelled with the reference numeral 600). The polarisation converter 600 has a cross-sectional structure, described here with respect to vertical axis 116-6 and horizontal axis 114-6, each perpendicular a light propagation direction 118-6 through the polarisation convertor 600, the vertical axis 116-6 perpendicular to the horizontal axis 114-6. The cross-sectional structure of the polarisation converter 600 of FIG. 12 comprises a waveguide layer 108-6 in between and in contact with a first cladding layer, which in this example is the substrate layer 102-6, and a second cladding layer 130-6. The waveguide layer comprises a first offset portion 112-6 partially bounded by first and second surfaces 106a-6, 106b-6, and a second offset portion 110-6 partially bounded by third and fourth surfaces 104a-6, 104b-6, and an intermediate portion 128-6 between the first and second joining surfaces 120a-6, 120b-6. The first joining surface 120b-6 joins the first and third surfaces 104b-6, 106b-6, and the second joining surface 120a-6 joins the second and fourth surfaces 104a-6, 106a-6. The intermediate portion thereby joins the offset portions to each other. Portion 110-6 is lower than portion 112-6 relative to the vertical axis 116. The intermediate portion 128-6 joining the offset portions 112-6, 110-6 is sloped, similar to the intermediate portions described with reference to FIGS. 2 and 3. In addition, the cross-sectional structure of the polarisation converter 600 of FIG. 12 features a sloped external surface 190 of the waveguide layer 108-6, forming a non-orthogonal (in other words, an acute or obtuse) internal angle α with the substrate layer 102-6 and the second cladding layer 130-6. As described with reference FIG. 11, this can be based on a crystalline plane of the waveguide layer 108-6 and formed through use of an under-etch technique.

As for the polarisation converters 100, 200, 400, 500 illustrated in FIGS. 2, 3, 10, 11, and 12, the cross-sectional structure of the polarisation converter 600 of FIG. 12 permits tilted modes and birefringence of these tilted modes. Δn electrical contact layer 132-5 can be used provides active control over the polarisation rotation achieved by the polarisation converter 600. By combining the offset portions and the external surface 190 being non-orthogonal to adjacent surfaces, the cross-sectional structure of polarisation converter 600 has a multitude of design parameters which can be selected to achieved desired tilted modes and birefringence in a straightforward manner.

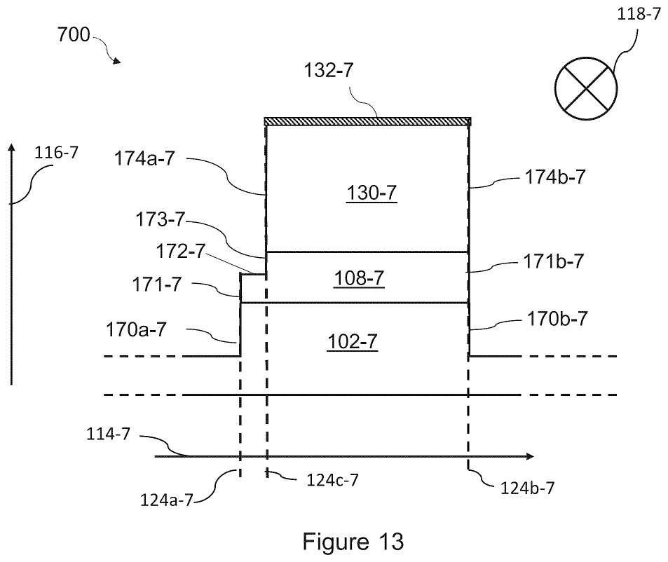

FIG. 13 is a schematic diagram of a polarisation converter 700 according to examples. The polarisation converter 700 has a cross-sectional structure, described here with respect to vertical axis 116-7 and horizontal axis 114-7, each perpendicular to a light propagation direction 118-7 through the polarisation convertor 700, the vertical axis 116-7 perpendicular to the horizontal axis 114-7. The cross-sectional structure of the polarisation converter 700 of FIG. 13 comprises a waveguide layer 108-7 in between and in contact with a first cladding layer, which in this example is the substrate layer 102-7, and a second cladding layer 130-7. Δn electrical contact layer 132-7, as described in previous examples, is used to apply a voltage and thereby achieve active control of the polarisation rotation performed by the polarisation converter 700 of FIG. 13.

The first cladding layer, substrate layer 102-7, comprises a first surface 170a-7 at a first position 124a-7 relative to the horizontal axis 114-7 and a second surface 170b-7 at a second position 124b-7 relative to the horizontal axis 114-7. The first surface 170a-7 (left-hand side relative to the orientation of FIG. 13) and second surface 170b-7 (right-hand side relative to the orientation of FIG. 13) therefore define a cross-sectional width of the substrate layer 102-7, which spans from the first position 124a-7 to the second position 124b-7.

The second cladding layer 130-7 comprises a first surface 174-7 at a third position 124c-7 relative to the horizontal axis 114-7, and a second surface 174b-7 at the second position 124b-7 relative to the horizontal axis 114-7. The first surface 174a-7 (left-hand side relative to the orientation of FIG. 13) and second surface 174b-7 (right-hand side relative to the orientation of FIG. 13) therefore define a cross-sectional width of the second cladding layer 130-7, which spans from the third position 124c-7 to the second position 124b-7. The third position 124c-7 lies in between the first position 124a-7 and the second position 12b-7, and so the cross-sectional width of the first cladding layer, substrate layer 102-7, is larger than the cross-sectional width of the second cladding layer 130-7.

The waveguide layer 108-7 comprises a first surface 171-7 at the first position 124a-7 and a second surface 173-7 at the third position 124c-7. The first surface 171-7 of the waveguide layer 108-7 is joined to the second surface 173-7 of the waveguide layer 108-7 by a joining surface 172-7, which is substantially (within acceptable fabrication tolerances) perpendicular to each. The waveguide layer 108-7 comprises a third surface 171b-7 which is at the second position 124b-7 relative to the horizontal axis. The waveguide layer 108-7 therefore has a first cross-sectional width, defined by the distance, relative to the horizontal axis 114-7, between first surface 171-7 of the waveguide layer 108-7 and the third surface 171b-7 of the waveguide layer, and a second cross-sectional width, again defined by the horizontal distance, between the second surface 173-7 of the waveguide layer 108-7 and the third surface 171b-7 of the waveguide layer 108-7.

The first surface 171-7 of the waveguide layer 108-7 can be described as offset from the second surface 173-7. In the examples of FIGS. 2 and 10, for example, the offset surfaces run parallel (or substantially parallel, within acceptable fabrication tolerances) to the horizontal axis 114, whereas in the examples of FIG. 13 the offset surfaces 171-7, 173-7 run parallel (or substantially parallel, within acceptable fabrication tolerances) to the vertical axis 116-7.

In the examples of FIG. 13, the first surface 171-7 of the cladding layer 108-7 is five times longer (in the direction of the vertical axis 116-7) than the second surface 173-7 of the cladding layer 108-7. The relative lengths of the surfaces 171-7, 173-7 and the joining surface 172-7, and therefore first and second cross-sectional widths, can be selected to achieve a desired mode tilt angle of the waveguide layer 108-7. In the example of FIG. 13, the mode angles are predominantly determined by (or in other words, most sensitive to) the first cross-sectional width. That is, in the examples of FIG. 13, lateral confinement of the mode is determined by the cross-sectional structure of the second cladding layer and the first cross-sectional width of the waveguide layer 108-7 extending to position 124c-7.

In other examples, the position of the offset surface may be different, such as either or both the first or second cladding layers having a step in their cross-sectional structure corresponding to an offset surface (thereby having two cross-sectional widths) as well as, or instead of, the waveguide layer.

The polarisation converter 700 having a waveguide layer 108-7 which has offset surfaces 171-7, 173-7 and therefore two cross-sectional widths introduces asymmetric boundary conditions which rotate the mode angles of the supported modes relative to a uniform planar waveguide layer.

Provision for tilted mode angles by geometric features of the cross-sectional structure profile per the examples illustrated by FIGS. 2, 3, 10, 11, 12 and 13 provides polarisation converters that can be manufactured straightforwardly. Active control, allowing a series of polarisation converters to be used as a polarisation scrambler or controller, can be further straightforwardly achieved by provision of a control element, such as an electrical contact layer, which may be or include an electrode, with which the effective refractive indices of the modes supported by the constituent polarisation converters can be modified. Such a polarisation control device may be readily manufactured in a generic platform by formation of just a single waveguide layer, or limited cladding layers and a waveguide layer, without requiring e.g. complex or heterogenous sub-layers to be formed.

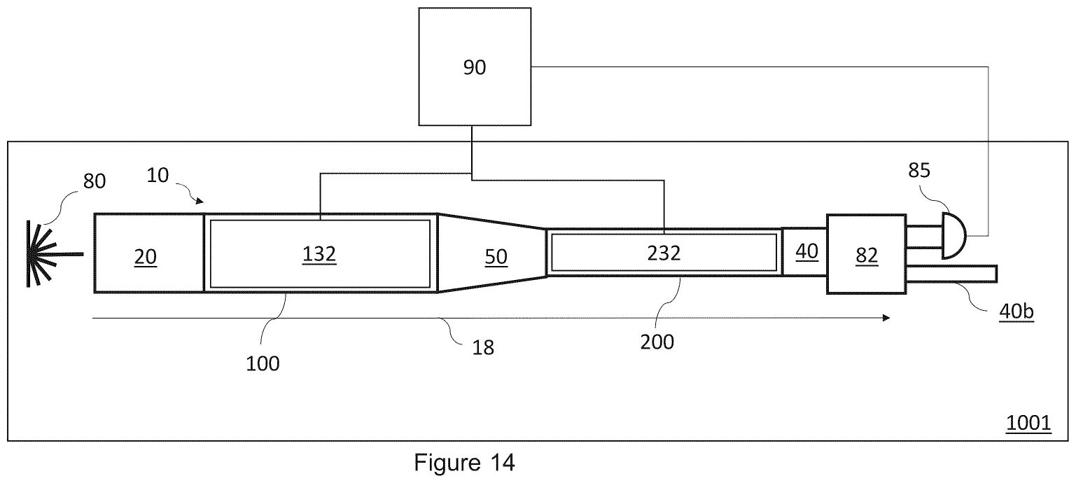

FIG. 14 illustrates schematically an example of a system 1500 comprising the polarisation control device 10 of FIG. 1 as part of a photonic integrated circuit 1001.

The photonic integrated circuit 1001 comprises an optical source 80 which in this example is an integrated laser source. Light from the optical source 80 is received at the input waveguide 20 of the polarisation control device 10. In other examples, light produced by the optical source of the system may be provided to other devices of the photonic integrated circuit before being received at the polarisation control device 10. The system 1500 comprises a control system 90 configured to provide signals to the electrical contact layers 132, 232 of the polarisation converters 100, 200 of the polarisation control device 10. The control system 90 may provide these signals to electrical contact layers 132, 232 through provision of electric circuitry (not pictured) within the photonic integrated circuit. The signals provided to the electrical contact layer, in this example, determine the potential difference which is applied to the respective polarisation converter. In other examples, the signals may determine a temperature for a heating element, the heating element in contact with the polarisation converter.

The control system 90 implements a control scheme to control a functionality of the polarisation control device 10. For example, the control system 90 may implement a control scheme enabling the polarisation control device 10 to function as a polarisation scrambler, or a control scheme enabling the polarisation control device 10 to function as a polarisation controller. The output waveguide 40 of the polarisation control device 10 outputs light, the output light having a state of polarisation which can be different to the state of polarisation of input light dependent upon the polarisation control implemented by the control system 90 interfacing with the polarisation control device 10.

The photonic integrated circuit comprises, after an output waveguide 40, an optical splitter 82 which provides a portion of the output light to a photodetector 85. The photodetector 85 is polarisation-dependent, such that it is sensitive to a first polarisation of light and insensitive to a second polarisation of light. In this example, the polarisation-dependence of the photodetector 85 is an inherent property of the photodetector, but in other examples the photodetector may be polarisation-insensitive, and the provision of polarisation filters before the photodetector can enable a similar measurement of polarisation of the output light. The photodetector 85 may be used, for example, for initial characterisation of the polarisation control device 10, and so interfaces with the control system 90 in order to inform the control scheme implemented by the control system 90. The photodetector may also be used during active usage of the device in order to provide feedback to the control system 90 by measuring the output state of light. The remaining portion of the light provided by the splitter is output from an output waveguide 40b.

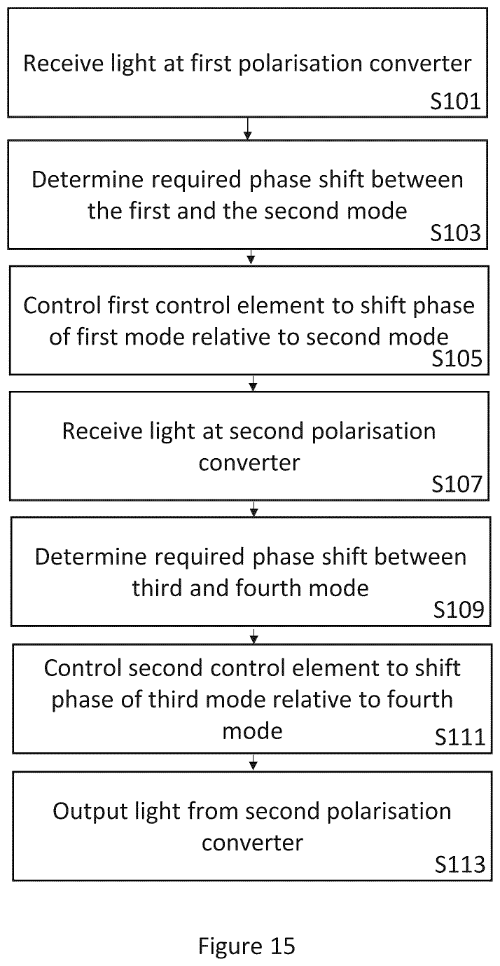

FIG. 15 is a flowchart illustrating a method of controlling a polarisation of light in a polarisation control device according to examples. In the example of FIG. 15, a method comprising controlling a polarisation control device such as the polarisation control device 10 of FIG. 1, which has two polarisation converters, is shown. However, the person skilled in the art, upon reading the description, will readily understand how the method of FIG. 15 could be extended to polarisation control devices comprising more than two polarisation converters, such as the polarisation control devices 11, 12 of FIGS. 8 and 9.

At item S101 of FIG. 15, light is received at the first polarisation converter. Light being received at a converter means, for example, that light is coupled into the modes supported by the converter. In other words, at item S101, light is coupled into the first mode and the second mode, which, as described previously, are for example tilted, or hybrid, modes. Light being received may have, for example, been propagating through free-space, such as coupling an off-chip light source directly into the polarisation control device, or may have been received after propagating through a waveguide such as the input waveguide 10. The person skilled in the art will appreciate that there are various ways in which light can be coupled into an integrated photonic circuit device.

At item S103, a required phase shift between the first and second modes is determined. This for example involves determining the phase shift required to modify the polarisation state from a first, input state to an intermediate output state of the first polarisation, according to a desired traversal path of the Poincaré sphere. Such a calculation uses knowledge of the tilt angles of the first and second modes, and therefore the rotational axis around which the Poincaré sphere will be traversed as a phase shift accrues. In general, this will involve the consideration of the polarisation conversion which will be achieved by subsequent polarisation converters, e.g. the second polarisation converter, in order to determine an overall traversal path of the Poincaré sphere realised by the polarisation control device 10. In this sense, whilst item S103 and later item S109 are presented separately, they can be considered to act together in determining how the polarisation state will be modified by the polarisation control device and may not be performed in a temporally separate manner.

In examples, item S103 may involve first determining the transfer function of the device (within fabrication tolerances). This can involve characterising the polarisation control device by providing TE mode light into the polarisation control device, and measuring the output polarisation of the device as the control voltages are swept through their respective ranges. This can enable the transfer function per section (e.g. for each constituent polarisation converter of the polarisation control device) to be calculated, which in turn can inform what polarisation conversion steps should be carried out by which polarisation converter, and hence determine the phase shift required by each polarisation converter.

In examples, item S103 may involve in-line measurement of the polarisation state at the first polarisation converter, e.g. by coupling a portion of the light away to make a polarisation measurement. In other examples, for example where the state of polarisation received by the first polarisation converter is known, or can be estimated to appropriate accuracy, item S103 may be performed without requiring measurement of the polarisation state of light. Calculations of item S103 may therefore, in some examples, take place before item S101.

At item S105, at least one first control element is controlled to shift the phase of the first mode relative the second mode according to the target phase shift calculated in item S103. In the case of the polarisation converters described in e.g. FIGS. 2, 3, where the control element includes an electrical contact layer, this involves applying an electric field via the electrical contact layer in order to modify the effective refractive indices of the first and second modes. In propagating through the first polarisation converter the first mode, having a first effective refractive index, and the second mode, having a second effective refractive index, acquire a phase difference. It is to be appreciated that, in other examples, the control element may be, for example, a heating element. In such cases, the control element is instead controlled to produce a temperature which results in the desired phase shift determined by step S103.

At item S107, light is received at the second polarisation converter. This involves coupling light into the third mode and the fourth mode. This may involve directly coupling light from the first mode and second mode of the first polarisation converter into the third mode and the fourth mode of the second converter by e.g. butt coupling, or may involve coupling the light using a connecting waveguide, which may e.g. have a taper, and which receives light from the first and second mode of the first polarisation converter, and, in some examples, adiabatically transitions to couple light into the third and the fourth mode.

At item S109, the required phase shift between third and fourth mode is determined. As per item S103, this for example involves determining what phase shift is required to rotate the input polarisation state (e.g. the output state of the first polarisation converter) into the desired output state of the polarisation control device. Such a calculation uses knowledge of the tilt angles of the third and fourth mode, and therefore the rotational axis around which the Poincaré sphere will be traversed as a phase shift accrues. As described for item S103, whilst the items of S103 and S109 are shown separately in FIG. 15, in examples they may be performed at the same time, e.g. before the device receives light, according to a control scheme.

At item S111, at least one second control element is controlled to shift the phase of the third mode relative to the phase of the fourth mode. In the case of the second polarisation converter 200 of FIG. 3, this involves controlling the electric field across the polarisation converter, via an electrical contact layer.

At item S113, light is output from the second polarisation converter. Through provision of items S105 and S111, the polarisation state of the light has been modified to a desired output state, which is output from the second polarisation converter. Similarly to item S107, this may involve first coupling light from the third and fourth mode into a connecting waveguide which e.g. adiabatically tapers to transition to mode-match with a receiving waveguide of the photonic integrated circuit.

In the example flowchart of FIG. 15, only two polarisation converters are used. Items S101, S103 and S105 may be repeated for subsequent polarisation converters in polarisation control devices with more than two polarisation converters, as the skilled person will appreciate.

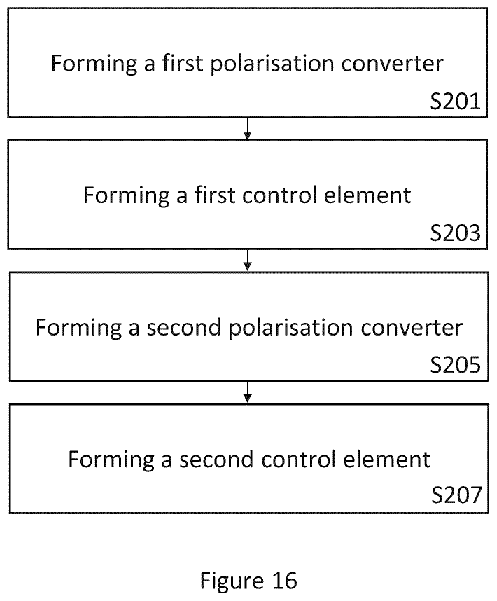

FIG. 16 is a flowchart illustrating a method of fabricating a polarisation control device according to further examples.

At item S201, a first polarisation converter is formed. In forming the first polarisation converter, a first cross-sectional structure is formed, the first cross-sectional structure being in a plane perpendicular to a first light propagation axis of the first polarisation converter. The first cross-sectional structure is configured to support a first mode and a second mode, whereby the orientation of polarisation of the first mode is different to the orientation of polarisation of the second mode. In other words, the first mode has a first tilt angle and the second mode has a second tilt angle, the first tilt angle different to the second tilt angle. The first mode has a higher effective refractive index than the second mode.

A polarisation converter and specifics of cross-sectional structure thereof may be formed by techniques known to the skilled person for fabrication of integrated photonic circuit elements, such as deposition, etching, lithography.

As the skilled person will appreciate, various techniques may be used to deposit a layer of semiconductor material in accordance with examples described herein. Such a technique may be known as a regrowth technique, for example a metalorganic vapour-phase epitaxy (MOVPE) or a molecular beam epitaxy (MBE) process may be used.

In some examples, the substrate material for a polarisation converter and/or photonic integrated circuit is InP. In some such examples, a wet etch procedure may be used in forming the polarisation control device. In some such examples, a wet etch procedure is performed using HC1: H3PO4: H2O. In some examples, a mixture of HCL, H3PO4 and H2O is selected which etches the desired material (in these examples, InP). In other examples, a mixture of HCL and H2O only is used as etchant. Performing a wet etch procedure, as described, provides an intermediate substrate surface (such as the joining surfaces 120a, 120b shown in FIG. 2) which is at an angle less than 90 degrees relative to an adjoining surface e.g. 104a, 104b shown in FIG. 2. Those skilled in the art will appreciate that the angle of the joining surface 120a, 120b would depend on the combination of the crystal structure of the substrate material, the etching chemicals and the particulars of the procedure used.

In examples, forming a polarisation convertor involves e.g. a dry etching procedure to remove material from either side of the structure, up to a particular depth as desired according to the intended application

At item S203, a first control element is formed. This can involve deposition of an electrical contact layer on top of the first polarisation converter, for example. In other examples, it can involve formation of a heating element on the first polarisation converter.

At item S205, a second polarisation converter is formed. In forming the second polarisation converter, a second cross-sectional structure is formed, the second cross-sectional structure being in a plane perpendicular to a second light propagation axis of the second polarisation converter. The second cross-sectional structure is configured to support a third mode and fourth mode, whereby the orientation of polarisation of the third mode is different to the orientation of polarisation of the fourth mode, and the orientations of polarisation of the third mode and fourth mode are different to the orientations of polarisation of the first mode and the second mode. The third mode has a higher effective refractive index than the fourth mode.

The second polarisation converter is formed such that an input of the second polarisation converter can receive light from an output of the first polarisation converter—that is, such that they can be arranged in series. The second polarisation converter can be formed using similar or the same techniques as the first polarisation converter.

At item S205, a second control element is formed. This can involve deposition of an electrical contact layer on top of the second polarisation converter, for example. In other examples, it can involve formation of a heating element on the second polarisation converter.

The above examples are to be understood as illustrative examples of the invention. Further examples of the invention are envisaged.

For example, an objective of obtaining a large range of polarisation control, potentially encompassing the entire Poincaré sphere, has been described thus far. However, in some examples, control encompassing the entire Poincaré sphere may not be required. For example, an application of the described polarisation control device may be to make minor polarisation modifications of unknown input polarisation states, where the input states are unknown but roughly at a certain polarisation, rather than being unknown and drawn from any possible polarisation on the Poincaré sphere. In such an example, it may only be necessary to use a plurality of closely-aligned rotational axes to perform the necessary polarisation control. Similarly, the polarisation control device, when operated in a polarisation-scrambler configuration, may not be required to generate polarisation states from the entire Poincaré sphere, but rather may only be required to generate polarisation states from a portion of the Poincaré sphere.

In various examples herein, a polarisation control device includes a waveguide layer between and in contact with a first and a second cladding layer, the first cladding layer being a substrate layer. In other examples, as will be understood by the skilled person, there may not be a second cladding layer. In such examples, the waveguide layer may only be in contact with a first cladding layer, and otherwise surrounded by e.g. air. In other examples, the first cladding layer is an additional layer disposed upon the substrate of the photonic integrated circuit. The cladding layers may comprise the same material, or have different compositions to each other, for example determined by optical performance of the polarisation converter.

The polarisation converter may be in series with an optical source, and used to control the polarisation output by the optical source. The optical source may form part of the photonic integrated circuit the polarisation control device is manufactured on, or may instead be external to the PIC and coupled into the polarisation control device.

Examples above include a control element in the form of an electrical contact layer for carrier injection or carrier depletion of the polarisation converter, such that voltage is applied across a polarisation converter. However, in other examples, carrier injection/depletion may not take place whilst a voltage is applied. In yet further examples, a different control element, e.g. a heating element, could be used instead to vary the effective refractive indices of the supported modes, or a mechanical element such as an acousto-optic modulator could instead be used as a control element of at least one control element of a polarisation control device.

In the above examples, different orientations of polarisation for the modes supported by a polarisation converter are achieved by variation of the cross-sectional width between each polarisation converter. In other examples, variation of other aspects of the cross-sectional structural geometry may instead or additionally be changed. For example, the internal angle of a sloped surface may vary between each polarisation converter to modify the tilt angles. In other examples, the relative amount of offset between portions of waveguide layers may be varied to achieve different tilt angles. In further examples still, each polarisation converter may have an entirely different cross-sectional structure to the others, e.g. according to the examples presented herein or variations thereof to vary the mode angles between the constituent polarisation converters. The cross-sectional width can thereby remain the same between each polarisation converter, as varying aspects other than the cross-sectional width of the cross-sectional structure to vary the orientations of polarisation of the supported modes can reduce or remove the requirement for tapered connecting sections and thereby reduce e.g. optical loss of the polarisation control device.

It is to be understood that any feature described in relation to any one embodiment may be used alone, or in combination with other features described, and may also be used in combination with one or more features of any other of the embodiments, or any combination of any other of the examples. Furthermore, equivalents and modifications not described above may also be employed without departing from the scope of the accompanying claims.

What is claimed is:

1. A polarisation control device for a photonic integrated circuit, comprising:
a first polarisation converter configured to support a first mode and a second mode, the first polarisation converter comprising:
a first cross-sectional structure in a plane perpendicular to a first light propagation axis of the first polarisation converter,
the first cross-sectional structure configured to at least partly determine an orientation of polarisation of the first mode and the second mode, respectively, the orientation of polarisation of the first mode different to the orientation of polarisation of the second mode, and
the first mode having a higher effective refractive index than the second mode;
a second polarisation converter configured to support a third mode and a fourth mode, the second polarisation converter comprising:
a second cross-sectional structure in a plane perpendicular to a second light propagation axis of the second polarisation converter,
the second cross-sectional structure configured to at least partly determine an orientation of polarisation of the third mode and fourth mode, respectively, the orientation of polarisation of the third mode different to the orientation of polarisation of the fourth mode, and
the third mode having a higher effective refractive index than the fourth mode;
the first polarisation converter connected in series with the second polarisation converter; and
at least one control element configured to, responsive to at least one signal:
modify effective refractive indices of the first mode and the second mode; and
modify effective refractive indices of the third mode and the fourth mode,
wherein the first cross-sectional structure is different to the second cross-sectional structure such that the first and second modes have different orientations of polarisation to the third and fourth modes.

2. The polarisation control device of claim 1, wherein:
the first cross-sectional structure has a first cross-sectional width, the first cross-sectional width defined by a distance between opposite surfaces of the first polarisation converter in a direction perpendicular to the first light propagation axis, and
the second cross-sectional structure has a second cross-sectional width, the second cross-sectional width defined by a distance between opposite surfaces of the second polarisation converter in a direction perpendicular to the second light propagation axis,
the first cross-sectional width being different to the second cross-sectional width, such that the first and second modes have different orientations of polarisation to the third and fourth modes; or:
the first cross-sectional structure has a first cross-sectional width, the first cross-sectional width defined by a distance between opposite surfaces of the first polarisation converter in a direction perpendicular to the first light propagation axis, and
the second cross-sectional structure has a second cross-sectional width, the second cross-sectional width defined by a distance between opposite surfaces of the second polarisation converter in a direction perpendicular to the second light propagation axis,
the first cross-sectional width being different to the second cross-sectional width, such that the first and second modes have different orientations of polarisation to the third and fourth modes, and at least one of:
the first cross-sectional width or the second cross-sectional width is in a direction parallel to a surface of the polarisation control device for arrangement on a substrate of the photonic integrated circuit.

3. The polarisation control device of claim 1, wherein at least one of:
the first cross-sectional structure comprises a first sloped surface, the first sloped surface having an acute or obtuse internal angle relative to a surface of the first cross-sectional structure adjoining the first sloped surface; or
the second cross-sectional structure comprises a second sloped surface, the second sloped surface having an acute or obtuse internal angle relative to a surface of the second cross-sectional structure adjoining the second sloped surface.

4. The polarisation control device of claim 1, wherein at least one of:
(i) the first cross-sectional structure comprises a layer comprising:
a first portion at least partially bounded by a first surface and a second surface, and
a second portion at least partially bounded by a third surface and a fourth surface,
the first surface offset from the third surface in a direction perpendicular to the first light propagation axis, the first surface connected to the third surface by a first joining surface, and
the second surface offset from the fourth surface in a direction perpendicular to the first light propagation axis, the second surface connected to the fourth surface by a second joining surface; or
(ii) the second cross-sectional structure comprises a layer comprising
a third portion partially bounded by a fifth surface and a sixth surface, and a fourth portion partially bounded by a seventh surface and an eighth surface,
the fifth surface offset from the seventh surface in a direction perpendicular to the second light propagation axis, the fifth surface connected to the seventh surface by a third joining surface, and
the sixth surface offset from the eighth surface in a direction perpendicular to the second light propagation axis, the sixth surface connected to the eighth surface by a fourth joining surface; or:
(iii) the first cross-sectional structure comprises a layer comprising:
a first portion at least partially bounded by a first surface and a second surface, and
a second portion at least partially bounded by a third surface and a fourth surface,
the first surface offset from the third surface in a direction perpendicular to the first light propagation axis, the first surface connected to the third surface by a first joining surface, and
the second surface offset from the fourth surface in a direction perpendicular to the first light propagation axis, the second surface connected to the fourth surface by a second joining surface,
wherein the first surface, the second surface, the third surface, and the fourth surface are parallel to each other; or
(iv) the second cross-sectional structure comprises a layer comprising
a third portion partially bounded by a fifth surface and a sixth surface, and a fourth portion partially bounded by a seventh surface and an eighth surface,
the fifth surface offset from the seventh surface in a direction perpendicular to the second light propagation axis, the fifth surface connected to the seventh surface by a third joining surface, and
the sixth surface offset from the eighth surface in a direction perpendicular to the second light propagation axis, the sixth surface connected to the eighth surface by a fourth joining surface,
wherein the fifth surface, the sixth surface, the seventh surface, and the eighth surface are parallel to each other.

5. The polarisation control device of claim 1, wherein:
(i) the first cross-sectional structure comprises a first intermediate portion, the second cross-sectional structure comprises a second intermediate portion, a structure of the second intermediate portion a mirror image of a structure of the first intermediate portion, in a plane perpendicular to the first and/or second light propagation axis; and/or
(ii) at least one of:
the first polarisation converter has a length parallel to the first light propagation axis substantially equal to an odd integer multiplied by a quarter of a beat length of a wavelength of input light; or
the second polarisation converter has a length parallel to the second light propagation axis substantially equal to an odd integer multiplied by a quarter of the beat length of the wavelength of the input light; and/or
(iii) wherein at least one of:
the first cross-sectional structure comprises a first waveguide layer between, and in contact with, a first cladding layer and a second cladding layer, the first waveguide layer having a higher refractive index than the first cladding layer and the second cladding layer; or
the second cross-sectional structure comprises a second waveguide layer between, and in contact with, a third cladding layer and a fourth cladding layer, the second waveguide layer having a higher refractive index than the third cladding layer and the fourth cladding layer; or
(iv) wherein at least one of:
the first cross-sectional structure comprises a first waveguide layer between, and in contact with, a first cladding layer and a second cladding layer, the first waveguide layer having a higher refractive index than the first cladding layer and the second cladding layer; or
the second cross-sectional structure comprises a second waveguide layer between, and in contact with, a third cladding layer and a fourth cladding layer, the second waveguide layer having a higher refractive index than the third cladding layer and the fourth cladding layer,
and at least one of:
the first waveguide layer is of indium gallium arsenide phosphide or indium aluminium gallium arsenide and the first cladding layer and the second cladding layer are each of indium phosphide; or
the second waveguide layer is of indium gallium arsenide phosphide or indium aluminium gallium arsenide and the third cladding layer and the fourth cladding layer are each of indium phosphide.

6. The polarisation control device of claim 1, wherein
(i) at least one of:
the first cross-sectional structure has a first cross-sectional width, the first cross-sectional width defined by a distance between opposite surfaces of the first polarisation converter in a direction perpendicular to the first light propagation axis,
the first cross-sectional width changing along a length parallel to the first light propagation axis; or
the second cross-sectional structure has a second cross-sectional width, the second cross-sectional width defined by the distance between opposite surfaces of the second polarisation converter in a direction perpendicular to the second light propagation axis,
the second cross-sectional width changing along a length parallel to the second light propagation axis; and/or
(ii) the first cross-sectional structure has a first cross-sectional width, the first cross-sectional width defined by a distance between opposite surfaces of the first polarisation converter in a direction perpendicular to the first light propagation axis, and
the second cross-sectional structure has a second cross-sectional width, the second cross-sectional width defined by a distance between opposite surfaces of the second polarisation converter in a direction perpendicular to the second light propagation axis;
the polarisation control device comprising:
a connecting waveguide, the first polarisation converter and the second polarisation converter joined by the connecting waveguide,
the connecting waveguide having a cross-sectional width in a direction perpendicular to a light propagation axis of the first connecting waveguide,
the cross-sectional width of the connecting waveguide tapering, along a length of the connecting waveguide, from the first cross-sectional width to the second cross sectional width; and/or
(iii) the first cross-sectional structure has a first cross-sectional width, the first cross-sectional width defined by a distance between opposite surfaces of the first polarisation converter in a direction perpendicular to the first light propagation axis, and
the second cross-sectional structure has a second cross-sectional width, the second cross-sectional width defined by a distance between opposite surfaces of the second polarisation converter in a direction perpendicular to the second light propagation axis;
the polarisation control device comprising:
a connecting waveguide, the first polarisation converter and the second polarisation converter joined by the connecting waveguide,
the connecting waveguide having a cross-sectional width in a direction perpendicular to a light propagation axis of the first connecting waveguide,
the cross-sectional width of the connecting waveguide tapering, along a length of the connecting waveguide, from the first cross-sectional width to the second cross sectional width, wherein the tapering of the connecting waveguide comprises an adiabatic taper.

7. The polarisation control device of claim 1, further comprising a third polarisation converter configured to support a fifth mode and a sixth mode,
the third polarisation converter comprising:
a third cross-sectional structure in a plane perpendicular to a third light propagation axis of the third polarisation converter,
the third cross-sectional structure configured to at least partly determine an orientation of polarisation of the fifth mode and the sixth mode, the orientation of polarisation of the fifth mode being different to the orientation of polarisation of the sixth mode of the sixth mode, and
the fifth mode having a higher effective refractive index than the sixth mode, wherein the at least one control element is configured to, responsive to the at least one signal and/or a further at least one signal, modify effective refractive indices of the fifth mode and the sixth mode, and
wherein the third cross-sectional structure is different to at least one of:
the first cross-sectional structure, such that the fifth mode and the sixth mode each have different orientations of polarisation to the first mode and second mode; or
the second cross-sectional structure, such that the fifth mode and the sixth mode each have different orientations of polarisation to the third mode and fourth mode.

8. The polarisation control device of claim 1, wherein the at least one control element is an electrode which is configured to, responsive to the at least one signal:
modify the effective refractive indices of the first mode and the second mode by application of an electric field across the first polarisation converter; and/or
modify the effective refractive indices of the third mode and fourth mode by application of an electric field across the second polarisation converter.

9. The polarisation control device of claim 1, wherein the polarisation control device is operable to perform at least two different polarisation control functions depending on the at least one signal received by the at least one control element.

10. The polarisation control device of claim 9, wherein the polarisation control device is operable as at least one of: a polarisation scrambler or a polarisation controller.

11. A photonic integrated circuit comprising the polarisation control device of claim 1.

12. The photonic integrated circuit of claim 11, further comprising:
an optical source for inputting light into the polarisation control device; and
an output waveguide for receiving light from the polarisation control device.

13. The photonic integrated circuit of claim 12, further comprising:
a third polarisation converter configured to support a fifth mode and a sixth mode, the third polarisation converter comprising:
a third cross-sectional structure in a plane perpendicular to a third light propagation axis of the third polarisation converter,
the third cross-sectional structure configured to at least partly determine an orientation of polarisation of the fifth mode and the sixth mode, the orientation of polarisation of the fifth mode being different to the orientation of polarisation of the sixth mode of the sixth mode, and
the fifth mode having a higher effective refractive index than the sixth mode, wherein the at least one control element is configured to, responsive to the at least one signal and/or a further at least one signal, modify effective refractive indices of the fifth mode and the sixth mode, and
wherein the third cross-sectional structure is different to at least one of:
the first cross-sectional structure, such that the fifth mode and the sixth mode each have different orientations of polarisation to the first mode and second mode; or
the second cross-sectional structure, such that the fifth mode and the sixth mode each have different orientations of polarisation to the third mode and fourth mode.

14. A system comprising the photonic integrated circuit of claim 11, the system comprising:
a control system configured to provide the at least one signal to the at least one control element to at least partly determine a polarisation of light at the output waveguide.

15. A method of manufacturing the polarisation control device of claim 1, the method comprising:
forming a first polarisation converter, the first polarisation converter comprising a first cross-sectional structure in a plane perpendicular to a first light propagation axis of the first polarisation converter, the first cross-sectional structure configured to support a first mode and a second mode, an orientation of polarisation of the first mode different to an orientation of polarisation of the second mode, the first mode having a higher effective refractive index than the second mode;
forming a second polarisation converter, the second polarisation converter comprising a second cross-sectional structure in a plane perpendicular to a second light propagation axis of the second polarisation converter, the second cross-sectional structure configured to support a third mode and a fourth mode, an orientation of polarisation of the third mode different to an orientation of polarisation of the fourth mode, the third mode having a higher effective refractive index than the fourth mode,
the first polarisation converter connected in series with the second polarisation converter,
the first cross-sectional structure different to the second cross-sectional structure such that the orientations of polarisation of the first and second modes are different to the orientations of polarisation of the third and fourth modes; and
forming at least one control element configured to, responsive to at least one signal, modify effective refractive indices of at least: the first mode and the second mode, or the third mode and the fourth mode.

16. The method according to claim 15, wherein
the first cross-sectional structure has a first cross-sectional width, the first cross-sectional width defined by a distance between opposite surfaces of the first polarisation converter in a direction perpendicular to the first light propagation axis,
the second cross-sectional structure has a second cross-sectional width, the second cross-sectional width defined by a distance between opposite surfaces of the second polarisation converter in a direction perpendicular to the second light propagation axis,
the first cross-sectional width being different to the second cross-sectional width, such that the first and second modes have different orientations of polarisation to the third and fourth modes.

17. The method according to claim 15, wherein forming at least the first polarisation converter or the second polarisation converter comprises forming at least the first cross-sectional structure or the second cross-sectional structure with a sloped surface, the sloped surface having an acute or obtuse internal angle relative to a surface of the first cross-sectional structure or the second cross-sectional structure adjoining the sloped surface.

18. The method according to claim 15, wherein the at least one control element is an electrode configured to, responsive to the at least one signal, apply an electric field across at least one of the first polarisation converter or the second polarisation converter.

19. A method of controlling light polarisation in a photonic integrated circuit, the method comprising:
receiving light at a polarisation control device of the photonic integrated circuit, the polarisation control device comprising:
a first polarisation converter configured to support a first mode and a second mode, the first polarisation converter comprising
a first cross-sectional structure in a plane perpendicular to a first light propagation axis of the first polarisation converter,
the first cross-sectional structure configured to at least partly determine an orientation of polarisation of the first mode and the second mode, the orientation of polarisation of the first mode different to the orientation of polarisation of the second mode, and
the first mode having a higher effective refractive index than the second mode;
a second polarisation converter configured to support a third mode and a fourth mode, the second polarisation converter comprising:
a second cross-sectional structure in a plane perpendicular to a second light propagation axis of the second polarisation converter,
the second cross-sectional structure configured to at least partly determine an orientation of polarisation of the third mode and the fourth mode, the orientation of polarisation of the third mode different to the orientation of polarisation of the fourth mode, and
the third mode having a higher effective refractive index than the fourth mode;
the first polarisation converter connected in series with the second polarisation converter;
at least one control element, responsive to at least one signal, configured to:
modify effective refractive indices of the first mode and the second mode, and
modify effective refractive indices of the third mode and the fourth mode;
wherein the first cross-sectional structure is different to the second cross-sectional structure such that the first and second modes have different orientations of polarisation to the third and fourth modes;
the method comprising:
receiving light at the first polarisation converter of the polarisation control device;
determining a required phase shift between the first mode and the second mode;
controlling the at least one control element to produce the required phase shift between the first mode and the second mode;
receiving light at the second polarisation converter of the polarisation control device;
determining a required phase shift between the third mode and the fourth mode;
controlling the at least one control element to produce the required phase shift between the third mode and the fourth mode.

20. The method of claim 19, wherein at least one of
the at least one control element comprises an electrode in electrical contact with the first polarisation converter, and to produce the required phase shift between the first mode and the second mode comprises applying a voltage across the first polarisation converter to modify the effective refractive indices of the first mode and the second mode; or
the at least one control element comprises an electrode in electrical contact with the second polarisation converter, and to produce the required phase shift between the third mode and the fourth mode comprises applying a voltage across the second polarisation converter to modify the effective refractive indices of the third mode and the fourth mode.
